(19) United States
(12) Patent Application Publication
(10) Pub. No.: US 2026/0164098 A1
(43) Pub. Date: Jun. 11, 2026

(54) METHODS, APPARATUSES AND COMPUTER PROGRAM PRODUCTS FOR FACILITATING MOTION TRANSFER FOR STYLIZING RADIANCE FIELDS

(71) Applicant: Meta Platforms, Inc., Menlo Park, CA (US)

(72) Inventors: Nikolaos Sarafianos, Castro Valley, CA (US); Rakesh Ranjan, Mountain View, CA (US); Seonghyeon Nam, Sunnyvale, CA (US); Hyunyoung Jung, Burlingame, CA (US)

(21) Appl. No.: 19/411,115

(22) Filed: Dec. 5, 2025

Related U.S. Application Data
(60) Provisional application No. 63/728,584, filed on Dec. 5, 2024.

(51) Int. Cl. H04N 21/81; G06T 19/00; G06V 10/77

(52) U.S. Cl. CPC H04N 21/816; G06T 19/006; G06V 10/7715

(57) ABSTRACT

Systems and methods to generate stylized content are provided. The system may select a first video including frames including a dynamic style of motion associated with content of the frames. The system may further analyze images associated with a first scene. The system may further apply the motion associated with the content of the frames of the first video to the analyzed images to generate a second scene including motion of media content associated with the images. The motion may provide a movement pattern to the media content during different viewpoints at respective timesteps of the second scene.

### CROSS-REFERENCE TO RELATED APPLICATIONS

This application claims priority to U.S. Provisional Application No. 63/728,584, filed Dec. 5, 2024, entitled “Motion Transfer For Stylizing Radiance Fields,” which is incorporated by reference herein in its entirety.

### TECHNOLOGICAL FIELD

Examples of the present disclosure relate generally to systems, methods, apparatuses, and computer program products for applying stylistic attributes to visual content using machine learning models.

### BACKGROUND

Style transfers may relate to defining a style as a set of fixed visual attributes derived from a single image. Some approaches, such as three-dimensional (3D) style transfer approaches focus on transferring static visual attributes, but may not apply motion. It may be difficult to determine how to apply a style to a static image, and especially to capture an essence of a style to motion and multiple images. For instance, when representing the style of “fire,” overlaying red flames onto 3D content may not necessarily bring out and convey the essence of fire. Existing 3D style transfer approaches may define “style” as a set of characteristics that a single Red-Green-Blue (RGB) image can provide, such as colors, textures, brush strokes, etc., however such a definition, and such application of existing 3D style transfer approaches, may limit the potential and applicability of style transfer technology. Accordingly, improved techniques may be needed to address current drawbacks.

### BRIEF SUMMARY

In meeting the described challenges, examples of the present disclosure may provide systems, methods, devices, and computer program products for generating visual content having particular stylistic attributes. Various examples may include systems and methods for extracting a motion style from a reference video comprising a plurality of frames indicating motion. A position-aware search to capture visual attributes may be applied to extract the motion style. Some example aspects of the present disclosure may further apply a dynamic radiance fields network to transfer the extracted style of motion to visual content and may render a stylized scene providing a continuous flow of viewpoint changes over time. In various examples, the visual content may be 3D visual content, and the stylized scene may include a dynamic four-dimensional (4D) scene. The visual attributes may include a color distribution and a movement pattern.

For example, the exemplary aspects of the present disclosure may provide a system that produces a 4D dynamic radiance field scene by combining the motion dynamics from a two-dimensional (2D) reference video, or images, to stylize a 3D scene (e.g., a static 3D scene). The 4D dynamic radiance field scene may display continuous flow of motion that may be included in the reference video, along with the original 3D content (e.g., fire may not only appear as flames but also may exhibit something burning). The system may perform multi-style interpolation by using a style video as an interpolation of multiple style images. The system may, but need not, be implemented within an augmented reality (AR), virtual reality (VR), and/or mixed reality environment (e.g., VR/MR headsets, AR glasses, etc.).

In one example of the present disclosure, a method is provided. The method may include selecting a first video including frames comprising a dynamic style of motion associated with content of the frames. The method may further include analyzing images associated with a first scene. The method may further include applying the motion associated with the content of the frames of the first video to the analyzed images to generate a second scene comprising motion of media content associated with the images. The motion may provide a movement pattern to the media content during different viewpoints at respective timesteps of the second scene.

In another example of the present disclosure, an apparatus is provided. The apparatus may include one or more processors and a memory including computer program code instructions. The memory and computer program code instructions are configured to, with at least one of the processors, cause the apparatus to at least perform operations including selecting a first video including frames comprising a dynamic style of motion associated with content of the frames. The memory and computer program code are also configured to, with the processor(s), cause the apparatus to analyze images associated with a first scene. The memory and computer program code are also configured to, with the processor(s), cause the apparatus to apply the motion associated with the content of the frames of the first video to the analyzed images to generate a second scene comprising motion of media content associated with the images. The motion may provide a movement pattern to the media content during different viewpoints at respective timesteps of the second scene.

In yet another example of the present disclosure, a computer program product is provided. The computer program product may include at least one non-transitory computer-readable medium including computer-executable program code instructions stored therein. The computer-executable program code instructions may include program code instructions configured to select a first video including frames comprising a dynamic style of motion associated with content of the frames. The computer program product may further include program code instructions configured to analyze images associated with a first scene. The computer program product may further include program code instructions configured to apply the motion associated with the content of the frames of the first video to the analyzed images to generate a second scene comprising motion of media content associated with the images. The motion may provide a movement pattern to the media content during different viewpoints at respective timesteps of the second scene.

In one example of the present disclosure, a system may be provided. The system may include at least one processor and at least one memory communicatively coupled to the at least one processor and comprising computer-readable instructions that upon execution by the at least one processor cause the at least one processor to perform operations including: extracting a motion style from a reference video comprising a plurality of frames indicating motion, wherein extracting the motion style comprises performing a position-aware search to capture visual attributes; applying a dynamic radiance fields network to transfer the extracted style of motion to visual content; and rendering a stylized scene providing a continuous flow of viewpoint changes over time.

In another example of the present disclosure, a computer program product may be provided. The computer program product may include at least one non-transitory computer-readable medium including computer-executable program code instructions stored therein. The computer-executable program code instructions may include program code instructions causing extraction of a motion style from a reference video comprising a plurality of frames indicating motion, applying a dynamic radiance fields network to transfer the extracted style of motion to visual content, and rendering a stylized scene providing a continuous flow of viewpoint changes over time. In some examples, extracting the motion style may include performing a position-aware search to capture visual attributes.

Additional advantages will be set forth in part in the description which follows or may be learned by practice. The advantages may be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the present disclosure; however, the disclosed subject matter is not limited to the specific methods, compositions, and devices disclosed. In addition, the drawings are not necessarily drawn to scale. In the drawings:

FIG. 1A and FIG. 1B illustrate an example model architecture, in accordance with various example aspects discussed herein.

FIG. 2A and FIG. 2B illustrate example stylizing techniques, in accordance with various example aspects discussed herein.

FIG. 3 illustrates example scenes stylized at different viewpoints and timesteps, in accordance with various example aspects discussed herein.

FIG. 4 illustrates qualitative comparisons of stylizing techniques, in accordance with various example aspects discussed herein.

FIG. 5 illustrates examples of position-aware nearest searches, in accordance with various example aspects discussed herein.

FIG. 6A, FIG. 6B and FIG. 6C illustrate iterative color transfer, in accordance with various example aspects discussed herein.

FIG. 7 illustrates multi-style interpolation, in accordance with various example aspects discussed herein.

FIG. 8 illustrates geometry stylization, in accordance with various example aspects discussed herein.

FIG. 9 illustrates a block diagram of an example device in accordance with various example aspects discussed herein.

FIG. 10 illustrates a block diagram of an example computing system in accordance with various example aspects discussed herein.

FIG. 11 illustrates a machine learning and training model in accordance with various example aspects discussed herein.

FIG. 12 illustrates a computing system in accordance with various example aspects discussed herein.

FIG. 13 is a diagram of an exemplary network environment in accordance with various example aspects discussed herein.

FIG. 14 illustrates an example of an artificial reality system comprising a headset, in accordance with an example of the present disclosure.

FIG. 15 illustrates another artificial reality system comprising a headset, in accordance with an example of the present disclosure.

FIG. 16 illustrates an example flowchart illustrating operations of a process in accordance with an example of the present disclosure.

The figures depict various examples for purposes of illustration only. One skilled in the art will readily recognize from the following discussion that alternative examples of the structures and methods illustrated herein may be employed without departing from the principles described herein.

### DETAILED DESCRIPTION

The present disclosure may be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular embodiments by way of example only and is not intended to be limiting of the claimed subject matter.

Some examples of the present disclosure will now be described more fully hereinafter with reference to the accompanying drawings, in which some, but not all examples of the present disclosure are shown. Indeed, various examples of the present disclosure may be embodied in many different forms and should not be construed as limited to the examples set forth herein. Like reference numerals refer to like elements throughout. As used herein, the terms “data,” “content,” “information” and similar terms may be used interchangeably to refer to data capable of being transmitted, received and/or stored in accordance with examples of the invention. Moreover, the term “exemplary”, as used herein, is not provided to convey any qualitative assessment, but instead merely to convey an illustration of an example. Thus, use of any such terms should not be taken to limit the spirit and scope of examples of the present disclosure.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional virtual worlds, online games (e.g., video games), one or more content items such as, for example, images, videos, non-fungible tokens (Fts) and in which the content items may, for example, be purchased with digital currencies (e.g., cryptocurrencies) and/or other suitable currencies. In some examples, a Metaverse or Metaverse network may enable the generation and provision of immersive virtual spaces in which remote users may socialize, collaborate, learn, shop and engage in various other activities within the virtual spaces, including through the use of Augmented/Virtual/Mixed Reality.

As referred to herein, a style video or video style, or reference video may be utilized interchangeably and may denote a sequence of consecutive 2D RGB frames that may represent a desired motion style, capturing characteristic color movements and pixel-wise shape variations intended for transfer to a target 3D scene.

As referred to herein, a UV map(s) may denote a 2D image that may define a manner in which colors and/or textures may be assigned to a surface of a 3D object(s).

References in this description to “an example”, “one example”, or the like, may mean that the particular feature, function, or characteristic being described is included in at least one example of the present invention. Occurrences of such phrases in this specification do not necessarily all refer to the same example, nor are they necessarily mutually exclusive.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

It is to be appreciated that certain features of the disclosed subject matter which are, for clarity, described herein in the context of separate embodiments, may also be provided in combination in a single embodiment. Conversely, various features of the disclosed subject matter that are, for brevity, described in the context of a single embodiment, may also be provided separately or in any sub-combination. Further, any reference to values stated in ranges includes each and every value within that range. Any documents cited herein are incorporated herein by reference in their entireties for any and all purposes.

### Exemplary System Operation

Example aspects of the present disclosure may relate to stylizing videos, image sets, and other visual content conveying motion using a style reference. The style reference may be a two-dimensional (2D) or 3D video, and various aspects may extract the style of motion conveyed in the video and transfer it to selected visual content. As result of the style transfer, a scene may be elevated to a different dimensionality, for example a content 3D scene may be elevated to a 4D dynamic scene which may display continuous flow of motion. In this manner, the 4D dynamic scene may be achieved/generated based on the content 3D scene being augmented with an additional temporal dimension(s), enabling the resulting output to express motion through time-dependent variations in pixel colors, shapes, and/or geometric displacement. The flow of motion may be included in the reference video along with the original 3D content. Aspects thereby improve upon previous methods by including the usage of 2D video as a style reference, the development of methods to transfer style from 2D video to a 3D scene(s), which may result in the elevation of a 3D static scene to a 4D dynamic scene.

Present techniques also improve upon traditional methods which primarily concentrate on transferring static aesthetic attributes to enhance visual stylization. Previously, 2D and 3D style transfer have been narrowly defined style as a set of fixed visual attributes derived from a single image. However, such narrowly defined styles, e.g., red flames to represent “fire,” may not sufficiently cover all that that style can convey. Aspects of the present disclosure therefore enable styles to be more expansively defined, e.g., not just by colors and shapes but also by the dynamics of motion and movement. For example, the style of fire may not only appear as flames but also exhibit burning. Water flows, and rain falls. By moving beyond the static limitations of images, the continuous flow and varying dynamics of styles may more effectively represent the intrinsic characteristics of different elements. Additionally, the inclusion of motion not only sets the atmosphere but also enhances the aesthetic appeal, thereby engaging viewers more deeply by creating a dynamic scene that mirrors realistic styles. Such techniques may also perform multi-style interpolation by treating different input image styles (e.g., paintings from various artists) as a video and smoothly interpolating between them while stylizing the input scene.

Style transfer, originally conceptualized as a method for injecting everyday images with artistic styles, has been extensively explored for various applications such as digital art, media creation, and asset stylization for VR/AR/MR. Its effectiveness and convenience enable usage across multiple 2D and 3D domains, including images, videos, meshes, and point clouds. Recent advancements in neural radiance fields (NeRF) have further broadened its applicability.

Style transfer also has high potential in mixed reality. In terms of connecting the virtual and real world, such techniques play a crucial role in creating artistic effect along with the real-world 3D environment that users live inside. This idea may be helpful for AR/VR/MR headsets, glasses, and other wearables to be developed focused on achieving a mixed reality world. 3D graphic designers may also be able to manually create the mixed 4D scene that combines the real-world static 3D scene and artistic dynamic effects. Accordingly, aspects of the present disclosure may enable simplification and efficiency via AI and deep learning techniques.

Accordingly, aspects of the present disclosure further develop style transfer in 2D and 3D domains, improving upon traditional approaches, which primarily focus on transferring static visual attributes, by applying dynamic elements to visual content. Motion Transfer, as discussed herein, transfer the unique dynamics and aesthetic attributes of each element, and incorporates motion to stylize static 3D scenes, and enable a broader definition of style that includes both visual attributes and the dynamics of motion.

Such techniques transform static 3D scenes into dynamic 4D experiences by leveraging a dynamic radiance fields network to transfer aesthetic attributes from 2D reference videos. This may enable the rendering of continuously evolving scenes that adapt visually over time, offering a more immersive and realistic stylization. Such techniques demonstrate the integration of motion into style transfer, significantly enrich the visual experience, and more authentically replicate the essence of dynamic styles.

In an example, given a target 3D static scene, Motion Transfer elevates it to a 4D dynamic scene by bridging the dimensional gap using motion extracted from 2D videos. Aspects may utilize a dynamic radiance fields network to initially fit the static target scene, and subsequently fine-tune this representation by transferring appearance and motion from the 2D reference video. As a result, the stylized scene may render various 3D spaces based on time input. These spaces collectively represent a continuous flow of appearance changes over time while allowing for viewpoint changes. Additionally, a position-aware nearest search may be applied to more accurately capture the intrinsic nature of the style and an iterative color transfer to precisely replicate the color distribution from style videos, thereby enhancing the quality of motion transfer.

Accordingly, Motion Transfer provides a technique that transfers the dynamics of motion from a 2D reference video to elevate static 3D scenes into 4D dynamic radiance fields. Position-aware search and iterative color transfer further enhance the aesthetic quality of the stylization and accurately reflect the color dynamics of the style source.

Neural style transfer. Convolutional neural networks and Gram matrix-based style loss may optimize the output image for style transfer. Numerous works have advanced this area by developing new loss formulations, achieving semantic consistency, and recently introducing the usage of attention mechanisms. To circumvent the need for tedious optimization with each stylization, feed-forward methods have been developed that enable zero-shot style transfer in real-time, where the network directly produces a stylized image without per-image optimization. As inferring the network for individual images causes temporal inconsistency, several works have developed methods for stylizing videos to achieve temporally coherent stylization. For example, an appearance translation network may be trained to stylize a few key examples and propagate the style throughout the video, implicitly preserving temporal consistency. Aspects of the present disclosure, however, do not aim to stylize video, but instead use video as a style reference.

3D style transfer. Style transfer techniques have expanded beyond 2D images to include 3D representations. Some techniques utilize back-projected image features onto 3D points and modulate them to stylize these representations. In another example, 3D point clouds from a target image may use graph convolution for encoding, or UV maps may be used to stylize the texture of reconstructed meshes. Neural Radiance Fields (NeRF) have gained prominence for their effectiveness, inspiring recent methods to stylize NeRF representations. Some techniques utilize a Gram matrix-based style loss within radiance fields, while reference-guided stylization selects an exemplar viewpoint to stylize and then propagates the style across other viewpoints.

Other techniques include implementing hash-grid encoding and bipartite matching to establish semantic correspondence between the style example and the content scene. Jung et al. introduced the use of depth maps to stylize both the shape and appearance of a 3D scene. A nearest neighbor feature matching loss (NNFM) may exploit feature similarity between content and style, aiming for aesthetic and well-structured stylization. Conversely, various methods may attempt arbitrary style transfer in 3D scenes to circumvent the scene-specific optimization typically required to stylize NeRF representations. For example, innovating the stylization of dynamic scenes using a single style image may maintain both spatial and temporal coherence. While some methods rely on static attributes from an RGB style image to stylize static or dynamic scenes, aspects of the present disclosure are differentiated by employing a style video as a reference. This distinct approach transfers dynamic attributes to a static 3D scene, effectively transforming it into a 4D dynamic field.

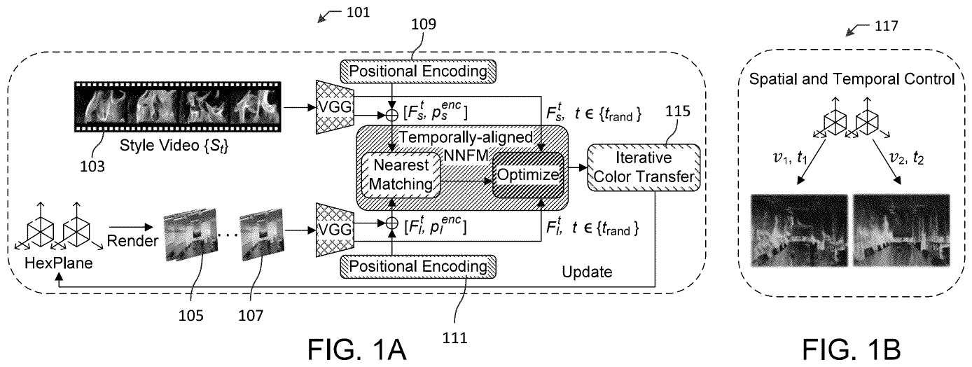

FIGS. 1A and 1B illustrate an overall architecture of such approaches discussed above, wherein FIG. 1A illustrates an example network, e.g., a HexPlane network, pre-trained on a static target scene(s). The network may be fine-tuned using a video St (also referred to herein as Sₜ) as a style reference. A temporally-aligned NNFM loss may be introduced to ensure that the rendered images correspond with the style video at matching time steps. During stylization, positional encoding (e.g., positional encoding 109, 111) and iterative color transfer (e.g., iterative color transfer 115) are applied to enhance the visual quality. FIG. 1B illustrates a spatial and temporal control technique (e.g., spatial and temporal control system 117) for stylization. After stylization, free control is enabled over the viewpoint and temporally varying appearance, allowing for the replication of motion in the video.

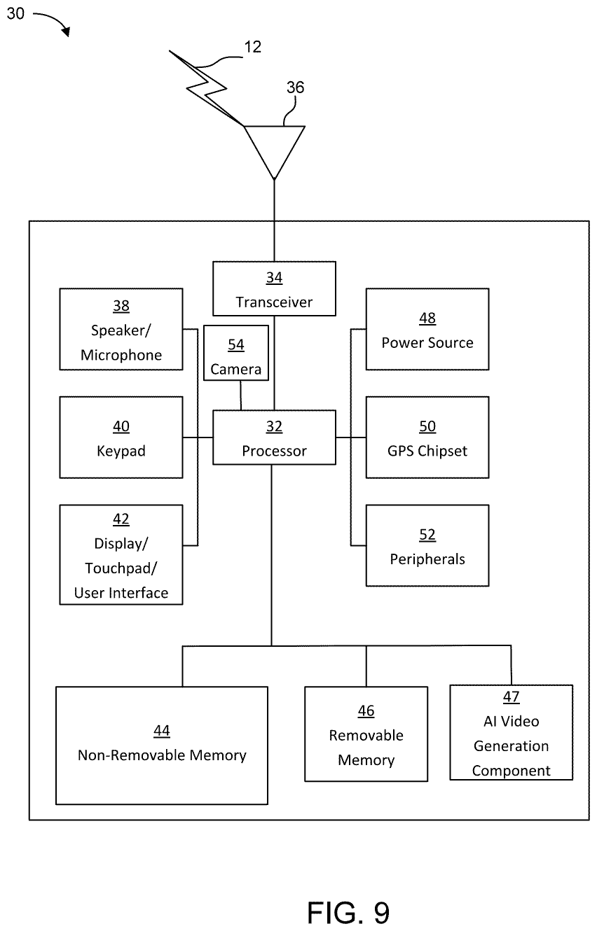

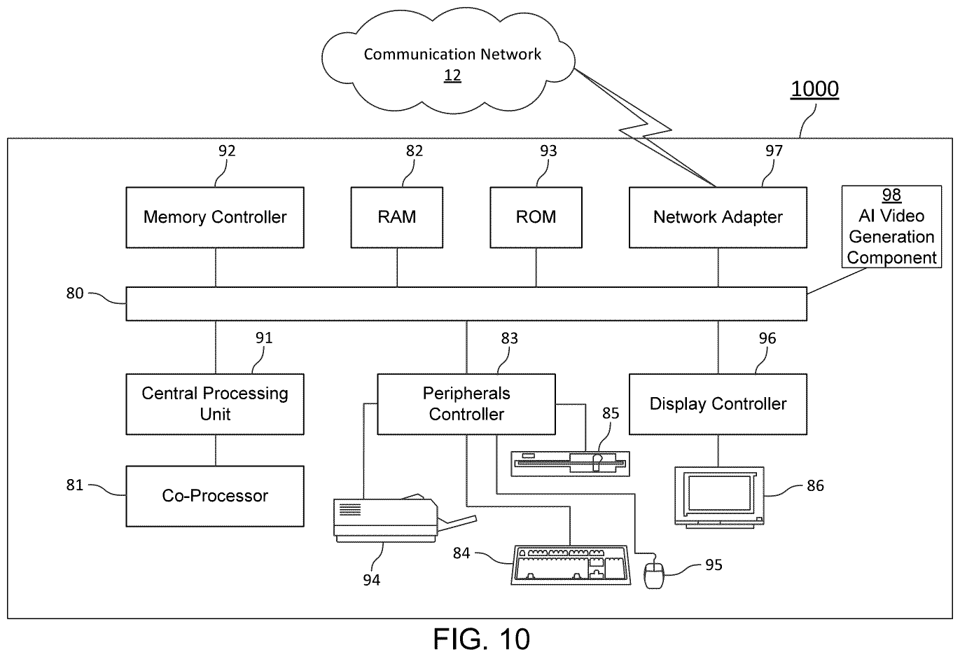

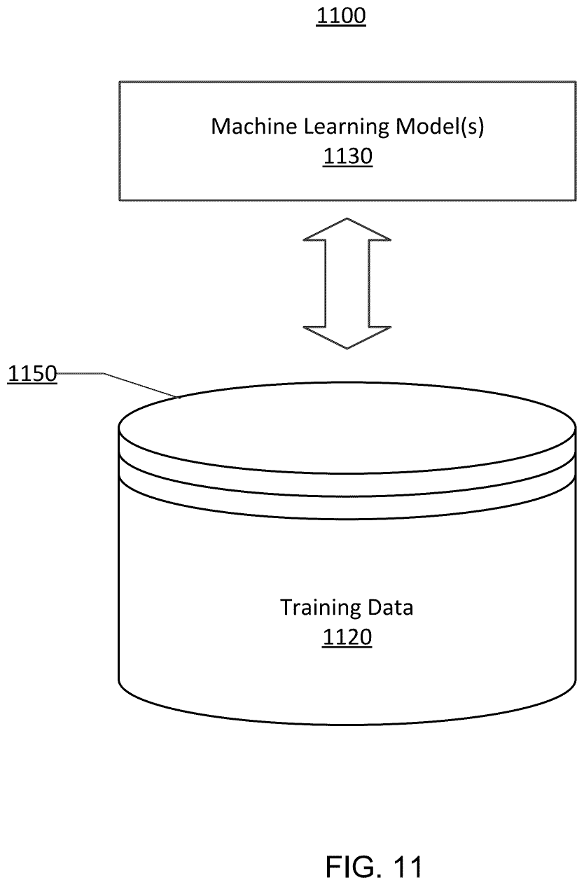

In FIG. 1A, the system (e.g., a HexPlane network 101) may apply a style video St as a style reference to one or more static images (e.g., images 105, image(s) 107), for example, multiple contiguous frames of a 2D video of a scene. In some example aspects, the HexPlane network may be implemented by a component(s) (e.g., AI video generation component 47 of FIG. 9, AI video generation component 98 of FIG. 10). In some examples, the HexPlane network may include several style videos having dynamic motion of various scenes, which may be generated based on corresponding scenes (e.g., video scenes). The style videos may be part of training data (e.g., training data 1120 of FIG. 11) associated with an (AI) model and/or an (ML) model (e.g., machine learning model(s) 1130 of FIG. 11). For purposes of illustration and not of limitation, for example, the style videos having dynamic motion may include burning fire video styles, lighting video styles, rain video styles, and/or any other number of suitable video styles of videos. The style videos may be trained on various scenes and may be part of training data (e.g., training data 1120) associated with the AI model and/or the ML model. In FIG. 1A, the video style 101 (e.g., a burning fire video style) may be selected (e.g., by the AI video generation component 47, AI video generation component 98 based on a determined type of images, or by a user of a device). The style video 103 may represent burning fire that has dynamic motion of flames burning.

The images 105, 107 may be images of a room (e.g., a conference room). The HexPlane network 101 may render the images having the video style of the flame at various positions in the images such that the video style (e.g., style video 103) of the fire having dynamic motion of burning flames in the room may represent a 3D scene (e.g., a 3D video). The HexPlane network may stitch (e.g., combine) the images (e.g., contiguous images (e.g., images 105, 107)) together in a contiguous manner as a generated video such that the generated video has the dynamic motion of flames burning in the room based on the style video 103.

The spatial and temporal control system 117 may utilize parameters (e.g., two parameters) as control in which one of the parameters may be v (e.g., v₁, v₂) and another parameter may be t (e.g., t₁, t₂) in which t may represent a timestamp(s) (also referred to herein as timestep(s)) and v may represent a viewpoint(s). The spatial and temporal control system 117 may take output of the iterative color transfer 115 and may render multiple static images from continuous viewpoints and timestamps, thereby enabling these static images (e.g., images 105, 107) to be stitched (e.g., combined) together into a video that exhibits motion-such as for example burning flames moving around the room-based on the style video 103. The spatial and temporal control system 117 may control t to select the timestamps of the style video (e.g., style video 103) which may be a 2D video and each of the different timestamps may be associated with different shapes of the fire/flames of the style video 103 such that when the timestamps are applied continuously (e.g., over a predetermined time period (e.g., 10 to 15 seconds, etc.), then the spatial and temporal control system 117 may represent, by rendering, the continuous motion of the generated video (e.g., video associated with v₁,t₁, and v₂,t₂) of the stitched images, which have the dynamic motion as represented in the style video 103. In this manner, the spatial and temporal control system 117 may render smooth different viewpoints having smooth dynamic motion to the images based on a determined or selected style video (e.g., style video 103) to generate a 4D dynamic scene.

For purposes of illustration and not of limitation, for example, a user may capture an image(s) (e.g., images 105, 107) of a room with headsets (e.g., HMD 1500), smart glasses (e.g., HMD 1410), or another device (e.g., UE 30, computer system 1000, computer system 1200) and may select a style video as a reference video, from among a plurality of style videos. For instance, in the example of FIG. 1A, the user may utilize the headsets, smart glasses or other device to select the style video 103 having the video of burning fire/flames. In this manner, the user may utilize a component/model (e.g., AI video generation component 47, AI video generation component 98, machine learning model(s) 1130) to create/generate a new room video having some motion of this burning fire/flames such that the user may control their viewpoints while controlling the timestamps of the generated video. As such, for example, in an instance in which the user wears a headset (e.g., HMD 1500), the user may view the new room overlaid in a video (e.g., 3D video) of an environment such as a real world environment or an AR/VR environment having the burning fire/flames.

In some other examples, a user of a device (e.g., HMD 1410, HMD 1500, UE 30, computing system 1000, computing system 1200) may select a style of a video (from among a plurality of style videos) that the user may desire to represent images (e.g., a captured image(s)) of interest to the user. Alternatively, an AI video generation component/model (e.g., AI video generation component 47, AI video generation component 98, machine learning model(s) 1130) may automatically select and apply a video style that the AI video generation component/model determines may be applicable to the images of interest to generate a video of a 3D rendered scene having the dynamic motion of the video style (e.g., style video 103) determined and selected by the AI video generation component/model. In some examples, the AI video generation component/model may determine the style video to select, among a plurality of style videos, based in part on a determining a type of the images of interest based on analyzing content of the images of interest.

Dynamic Radiance Fields. While the NeRF capability for photorealistic rendering was previously confined to static 3D scenes, as seen in FIGS. 1A and 1B, D-NeRF may be introduced to extend neural radiance fields to dynamic scenarios. The employed deformation fields may map from a static canonical space to a temporally varying deformed space. Accordingly, techniques may include modeling of non-rigid objects, e.g., reconstructing the human body, and enhancing both rendering quality and efficiency. As shown in FIGS. 1A and 1B, aspects may utilize a HexPlane, a voxel-based method that decomposes a 4D grid into space-time feature planes (e.g., six space-time feature planes, seven space-time feature planes, etc.), to achieve fast convergence and rendering efficiency.

4D generation. Generating a 4D scene is highly challenging due to its high degree of freedom and the inherently ill-posed nature of the task. Aspects of the present disclosure provide a text-to-video diffusion model may guide the dynamic NeRF optimization process, enabling the generation of 4D objects described by text prompts. 4D objects from a single image combined with text inputs may be guided by a video diffusion model. While such methods focus on generating 4D objects from text prompts using diffusion models, aspects of the present disclosure may stylize static 3D scenes and elevate the static 3D scenes to realistic dynamic scenes using a 2D video guide.

Method. In some examples, the method(s) of the exemplary aspects may be implemented by the AI video generation component 47, the AI video generation component 98 and/or the machine learning model(s) 1130. Given a set of multi-view images {Iᵥ_{ᵢ}}ᵢ, each capturing a static target 3D scene from a specific viewpoint, and a reference style guide in the form of a 2D video consisting of T images across consecutive time frames,

$${\{ {S}_{t} \}}_{t = 1}^{T} .$$

Thus, a rendering network, Fθ, is developed to models 4D dynamic radiance fields. The network thereby aims to generate outputs at any given time step t and viewpoint vi as defined by:

$${\hat{I}}_{{υ}_{i} t} = {ℱ}_{θ} ( {υ}_{i} , t ) \qquad ( 1 )$$

When the renderer generates images across the continuous time frames between [1,T], the resulting sequence of rendered images

$${\{ {\hat{I}}_{t} \}}_{t = 1}^{T}$$

accurately reflects the appearance changes and motions along with the target 3D scene as depicted in the style video.

HexPlane Representation. To transform static 3D scenes into dynamic radiance fields, systems and methods approach models appearance changes along the temporal dimension. The HexPlane may be utilized as the basis for the rendering network, Fθ. HexPlane incorporates two distinct 4D volumes to facilitate this transformation: one volume handles spatially and temporally varying features for appearance, while the other manages volume density. To achieve faster convergence and reduce memory usage, HexPlane employs a vector-matrix decomposition, which breaks down these volumes into six features spanning the spatial and temporal coordinate axes.

Motion Transfer from Video. To represent a dynamic 3D scene, it may be conceptualized as a sequence of static 3D scenes corresponding to each time step {V₁, V₂, . . . , V_{T}}. The core idea is to stylize each 3D volume Vₜ using an RGB style guide Sₜ, which is sampled from a 2D video at the respective time step t. Upon completion of the stylization process, these individual static scenes may be combined to form a dynamic 3D scene.

Stylizing a 3D Scene from an Image. A static 3D scene, Vₜ, may then be stylized using a style image, Sₜ, through a style loss which is adopted as NNFM. For each time step t and a sampled viewpoint υᵢ, the image Î_{vi,t} is rendered and VGG feature maps is extracted, denoted as F_{I} from Î_{vi,t} and F_{S} from the style image, Sₜ. The NNFM loss begins with a nearest neighbor search to identify the closest match between these feature maps and then minimizes the cosine distance, d_{cos}, between them:

$${i}^{′} = arg {min}_{j} {d}_{c o s} ( {F}_{I} ( i ) , {F}_{S} ( j ) ) , {L}_{style} ( i ) = {d}_{c o s} ( {F}_{I} ( i ) , {F}_{S} ( {i}^{′} ) ) . \qquad ( 2 )$$

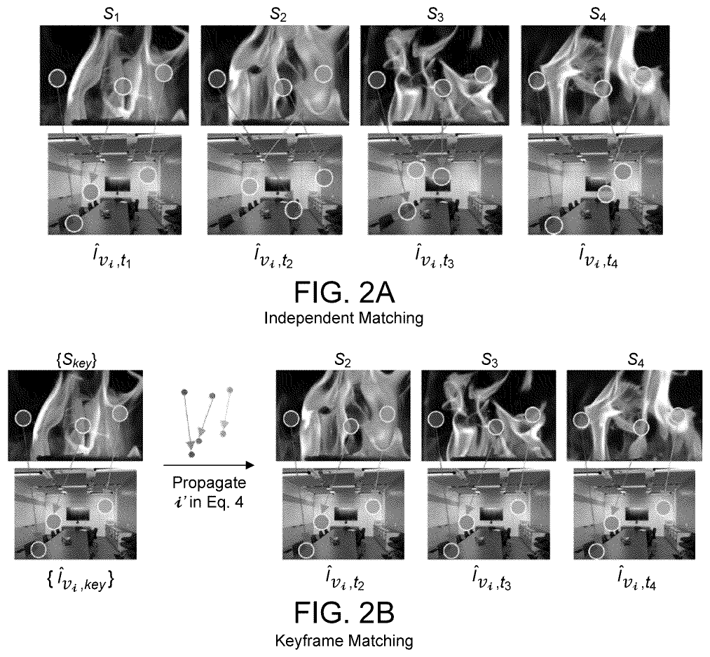

A straightforward extension of it to handle multiple style images, (e.g., a style video), involves applying the style loss across various content-style pairs at different time steps. However, this approach encounters challenges due to the spatially-local nature of motion in the video. Despite frames being consecutively sampled from the video, referencing different spatial locations in each frame does not guarantee continuity in appearance changes and motion. This is because, when applying the style loss across multiple time steps, the target location i′ is selected independently for each time step (see, e.g., FIG. 2A). This disjointed selection disrupts the continuity between consecutive 3D scenes V₁, V₂, . . . , V_{T}, leading to multiple snapshots of static frames rather than depicting continuous motion in the style video.

FIG. 2A illustrates an exemplary process of independent matching frames of a style video and one or more images. FIG. 2B illustrates a process of keyframe matching frames of style video and one or more images. FIG. 2A shows two types of images in which the bottom images may be the rendered 3D scene in the same viewpoint (vᵢ) associated with different timesteps while the top images may be images of a selected/determined style video (s) in a timestep(s) corresponding to the bottom images of the rendered 3D scene. Furthermore, regarding FIG. 2A in an instance in which the nearest location is independently selected across multiple timesteps (e.g., t₁, t₂, t₃, t₄), each of the regions in the corresponding rendered image(s) (e.g., images 105, 107) may be stylized with different spatial locations associated with different viewpoints (e.g., vᵢ) from the style video (e.g., style video 103) at each of the corresponding timesteps. When the independent matching process of FIG. 2A is utilized/applied, depending on each timestep(s) in the same viewpoint(s), the motion may not be changed as smoothly as desirable. This is because the nearest style-location is selected independently at each timestep, allowing different frames to match to different spatial regions of the style video. Such frame-by-frame variation may break temporal consistency, causing the transferred motion to jump or flicker rather than flow smoothly. To resolve this, the keyframe matching process of FIG. 2B may be utilized to perform matching on keyframes and propagates these matched locations to intermediate frames, thus achieving smooth motion of the style video (e.g., style video 103) to the corresponding images (in the same viewpoint(s)) of the 3D rendered scene. As shown in FIG. 2B, the system of the exemplary aspects may perform nearest-location matching on a small set of keyframes, which may act as temporal anchors for the style video. The matched location from these keyframes is then propagated to intermediate frames, ensuring that the same region of the style video is consistently referenced over time. This may prevent abrupt changes between frames and produces a smooth, continuous motion flow in the rendered 3D images.

Temporally-aligned NNFM. To address this issue and ensure continuity across time steps, it is crucial that i′ is consistently selected across all frames. In other words, this requires a single nearest location that remains consistent throughout all time steps. Consequently, Eq. 2 may be extended to accommodate the style video as follows:

$${i}^{′} = arg {min}_{j} {\sum }_{t = 1}^{T} {d}_{c o s} ( {F}_{I}^{t} ( i ) , {F}_{S}^{t} ( j ) ) , \qquad ( 3 )$$

where F^{t} denotes the VGG feature maps from the images at timestep t. To approximate this, key timesteps, {t_{key}}, may be sampled and uniformly selected to divide the entire range of timesteps, [1, T]. For each key timestep t∈{t_{key}}, a distance matrix

$${D}_{i}^{t} ∈ {ℝ}^{{H}_{S} \times {W}_{S}}$$

may first be computed, which represents the cosine distances between a single content feature vector,

$${F}_{I}^{t} ( i ) ,$$

and all vectors in the style feature maps,

$${F}_{S}^{t} .$$

Subsequently, the closest location i′ is selected throughout the video to minimize the sum of the distance matrices across the key frames as follows:

$${i}^{′} = arg {min}_{j} {\sum }_{t ∈ {t}_{k e y}} {D}_{i}^{t} ( j ) , \qquad ( 4 )$$

Optimization. Although the nearest search is conducted exclusively with keyframes, actual optimization must be performed for every timestep to accurately learn continuous motion. For the optimization at each iteration, multiple timesteps, {t_{rand}}, may be randomly sampled from the range [1, T]. For each time t∈{t_{rand}}, the cosine distance between the content feature vector and the style feature may be optimized at the pre-computed position i′ from Eq. 4 as shown in FIG. 2B. The style loss L_{style} is defined as:

$${L}_{style} = \frac{1}{{H}_{I} {W}_{I}} {\sum }_{i} {L}_{s t y l e} ( i ) , \qquad ( 5 )$$

$$where {L}_{s t y l e} ( i ) = \frac{1}{\vert \{ {t}_{rand} \} \vert} {\sum }_{t ∈ {t}_{r a n d}} {d}_{c o s} ( {F}_{1}^{t} ( i ) , {F}_{S}^{t} ( {i}^{′} ) )$$

The algorithm, or application, of the motion transfer is outlined in Algorithm 1 (also referred to herein as Application 1). In some example aspects, the machine learning model(s) 1130, the AI video generation component 47 and/or the AI video generation component 98 may utilize, implement and/or execute the Algorithm 1/Application 1.

Algorithm 1 Motion Transfer

```
HexPlane: F_{θ}, style images: {S₁, S₂, ... , S_{T}}, camera viewpoints: {v}
  repeat
      Sample vᵢ ~ {v}
      Render Î vi,t for all t ∈ {t_{key}}
      Perform nearest search to find optimal location (i′ in Eq. 4)
      Sample {t_{rand}} ~ [1, T]
      for all t ∈ {t_{rand}} do
        Render Î vi,t
        Compute L_{style} using Eq. 5
        Accumulate gradients via back-propagation
  end for
      Update θ using gradient descent
    until maximum iterations are reached
```

### Position-Aware Nearest Search

To better capture a realistic sense of motion from the style, it is important to accurately map spatially varying parts of the video to corresponding locations within the 3D scene. Additionally, nearest matching often leads to reduced diversity, as the process tends to focus on specific parts of the style image. To address this issue, the positional information of both the content 3D scene and the style video may be utilized during the matching process illustrated in Eq. 4.

Each pixel location of the rendered image Îᵥ_{ᵢ}_{,t} may be converted into a world coordinate p_{I}∈ [symbol] ^{H}^{_{I}}^{×W}^{_{I}}^{×3}, using its estimated depth \hat{D}ᵥ_{ᵢ}_{,t} from the rendering network. For the style video, the average pose E[vᵢ] may be computed/determined from the training images (e.g., content images) and set as the viewpoint for the style image. Subsequently, the pixel locations of the style image may be converted into 3D points p_{S}∈ [symbol] ^{H}^{_{I}}^{×W}^{_{I}}^{×3}, after uniformly setting their depth to a fixed value at the center of the 3D space.

Following this, positional encoding may be applied to transform both p_{I} and p_{S} into sinusoidal vectors

$${p}_{I}^{e n c} and {p}_{S}^{e n c}$$

which are then concatenated with the image feature maps during the nearest search:

$${i}^{′} = arg {min}_{j} {\sum }_{t ∈ {t}_{k e y}} {D}_{i , p}^{t} ( j ) , \qquad ( 6 )$$

$$where {D}_{i , p}^{t} ( j ) = {d}_{c o s} ( [ {F}_{I}^{t} ( i ) , {p}_{I}^{e n c} ( i ) ] , [ {F}_{S}^{t} ( i ) , {p}_{S}^{e n c} ( j ) ] )$$

Iterative Color Transfer. Solely minimizing the cosine distance between content and style features lacks the ability to accurately transfer colors. To address this, some techniques propose a view-consistent color transfer as a pre- and post-processing step. This involves computing a transformation matrix A such that E[Ac]=E[s] and Cov[Ac]=Cov[s]. Here, c and s denote the set of all pixel colors in the rendered images at training viewpoints and in the style image, respectively.

To adapt this approach to scenarios involving multiple style images, A, for each key timestep t∈{t_{key}} as A^{t} may be computed, to satisfy E[Aₜcₜ=E[Sₜ]] and Cov[Aₜcₜ=Cov[sₜ]]. Here, cₜ and sₜ are the sets of pixel colors in rendered images at time t and in style image Sₜ, respectively.

During runtime, rendering networks may produce output colors Aₜcₜ at any given time t. Thus, if the input time step is t∉{t_{key}}, Aₜ between Aₜ_{ₐ} and Aₜ_{_{b}} is linearly interpolate, where tₐ≤t<t_{b} and both tₐ and t_{b} are key time steps:

$${A}_{t} = \frac{( t - {t}_{a} )}{{t}_{b} - {t}_{a}} \cdot {A}_{{t}_{a}} + \frac{( {t}_{b} - t )}{{t}_{b} - {t}_{a}} \cdot {A}_{{t}_{b}} , for t ∉ \{ {t}_{k e y} \} . \qquad ( 7 )$$

Additionally, using these transformations as a post-processing step often leads to overly rough and aliased patterns. Therefore, they may be integrated into training pipelines. For example, at fixed intervals during stylization, {Aₜ} and set Aₜ may be computed/determined as a final layer in the network, thus calculating the style loss with transformed colors. This layer is fixed and not updated via gradient descent; however, it is recalibrated every fixed number of iterations. The recalibration process involves updating

$${A}_{t} to {A}_{t}^{n e w} = {A}_{t}^{′} {A}_{t}^{old} ,$$

where

$$E [ {A}_{t}^{′} {A}_{t}^{old} {c}_{t} = E [ {s}_{t} ] ] and Cov [ {A}_{t}^{′} {A}_{t}^{old} {c}_{t} = Cov [ {s}_{t} ] ] .$$

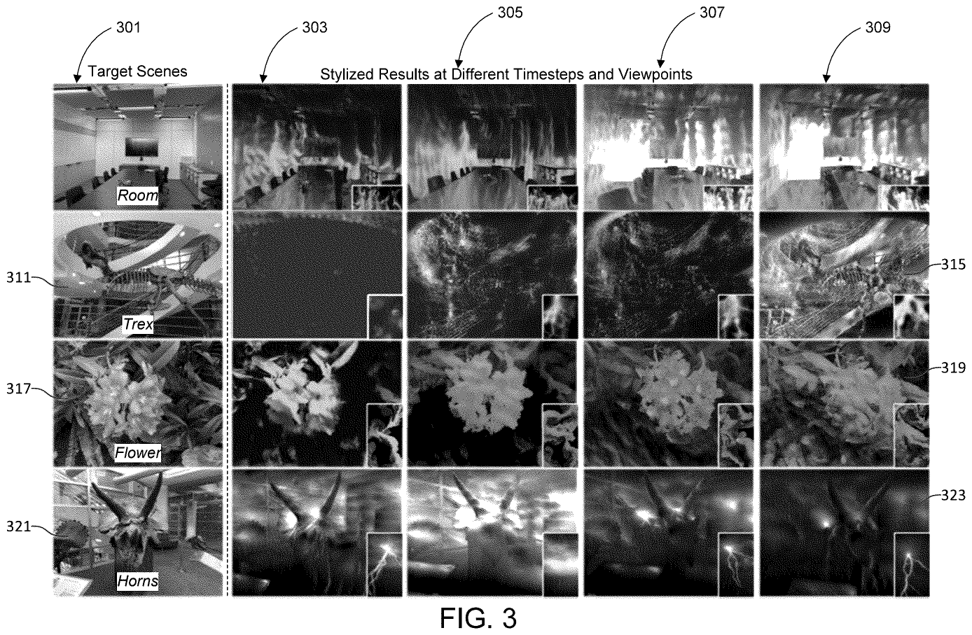

FIG. 3 illustrates stylized scenes rendered at multiple viewpoints and timesteps. Each style image represents frames from a style video at the corresponding timestep. For a target scene 301 associated with an image(s) of a room (e.g., conference room, etc.), a component/model (e.g., AI video generation component 47, AI video generation component 98, machine learning model(s) 1130) may apply a style video (e.g., style video 103) having dynamic motion of burning fire/flames to generate stylized renderings at different timesteps and viewpoints of the target scene (e.g., images 303, 305, 307, 309). In the example of FIG. 3, the images 303, 305 may be of red-color burning flames and the images 307, 309 may be of white-color burning flames, reflecting the temporal transition from red flames to white flames shown in the style video (e.g., style video 103). Additionally, for a target scene 311 associated with an image(s) of dinosaur (e.g., Tyrannosaurus rex (trex)) bones in a museum, the component/model (e.g., AI video generation component 47, AI video generation component 98, machine learning model(s) 1130) may apply a style video (e.g., a rain style video) having dynamic motion of rain drops to generate stylized renderings at different timesteps and viewpoints (e.g., image 315, etc.) of the target scene 311. In the example of FIG. 3, the sequence of images may reflect the manner in which the intensity and/or appearance of the rain motion varies over time according to the rain style video. The images from left to right of the target image 311 may show a most intense (e.g., the most/heaviest rain drops) motion of rain becoming progressively less intense motion of rain drops in images (e.g., with the least rain drops motion in image 315 for example).

Furthermore, for a target scene 317 associated with an image(s) of a flower in an environment, the component/model (e.g., AI video generation component 47, AI video generation component 98, machine learning model(s) 1130) may apply a style video (e.g., a flower growth style video) having dynamic motion of stages of growth of a flower to generate stylized renderings at different timesteps and viewpoints (e.g., image 319, etc.) of the target scene 317. In the example of FIG. 3, the sequence of stylized images may reflect the manner in which the appearance of the flower changes over time according to the flower-growth style video. The images from left to right associated with the target scene 317 may show a temporal progression from earlier stages of flower growth to later stages of flower growth, with image 319 showing the most advanced growth stage illustrated associated with the style video.

In addition, for a target scene 321 associated with an image(s) of animal horns in an environment, the component/model (e.g., AI video generation component 47, AI video generation component 98, machine learning model(s) 1130) may apply a style video (e.g., a lightning style video) having dynamic motion of varying intensity of lightening to the horns in the environment to apply to different timesteps and viewpoints of corresponding images (e.g., image 323, etc.) of the target scene 321. In the example of FIG. 3, there may be three images having various lightning intensity motion applied, based on the lightning style video, to images associated with the target scene 321. The images from left to right associated with the target image 321 may show a progression of motion for the least amount of lighting motion intensity applied to an image of the horns to the most lightning intensity motion to an image (e.g., image 323) of the horns.

### EXPERIMENTS

Implementation details. Aspects of the present disclosure may adopt a HexPlane-slim, which may exclude the density Multi-layer Perceptron (MLP), as the rendering network. Initially, the network (e.g., AI video generation component 47, AI video generation component 98, machine learning model(s) 1130) may be trained on static 3D scenes, where time inputs for each 3D point sample along rays are uniformly sampled between [0, 1] during the reconstruction stage. After reconstruction, the pre-trained network may be fine-tuned using the motion transfer algorithm (e.g., Application 1). Since the method requires rendering images multiple times in a single iteration, images may be rendered at half-size to reduce runtime. Deferred back-propagation may also be used with gradient caching to save memory usage. The stylization process requires 1,000 (1K) iterations, taking approximately 8 to 10 hours per scene on a V100 32 GB (Gigabyte) GPU (Graphical Processing Unit). In an example, 250 frames were used for all style videos, designating 8 as keyframes, t_{key}, which are spaced evenly across the sequence, including the first and last frames. In an example, N_{rand}=32 during the optimization stage. For the NNFM loss computation, a patch-wise scheme may be employed to capture the movement of larger patterns. During stylization, a content loss may also be incorporated. Color transfer may be applied every 300 iterations, e.g., at 300, 600, and 900 iterations, and updated finally as a post-processing step after stylization is complete. The experiments were mainly conducted on the real-world forward facing scenes in the LLFF dataset.

### Qualitative Results.

Temporal and spatial control. FIG. 3 illustrates example results of stylizing various scenes from different viewpoints and at various timesteps. 4D stylization, as discussed herein, allows images to be rendered freely at multiple viewpoints while also modeling appearance changes that correspond to different timesteps of their style videos. These results illustrate that motion transfer algorithms (e.g., Algorithm 1/Application 1) may handle both local appearance changes such as burning fire and global appearance changes, as seen in the transition of entire scenes from red fire to white fire (top row) and from dark blue to light blue (second row).

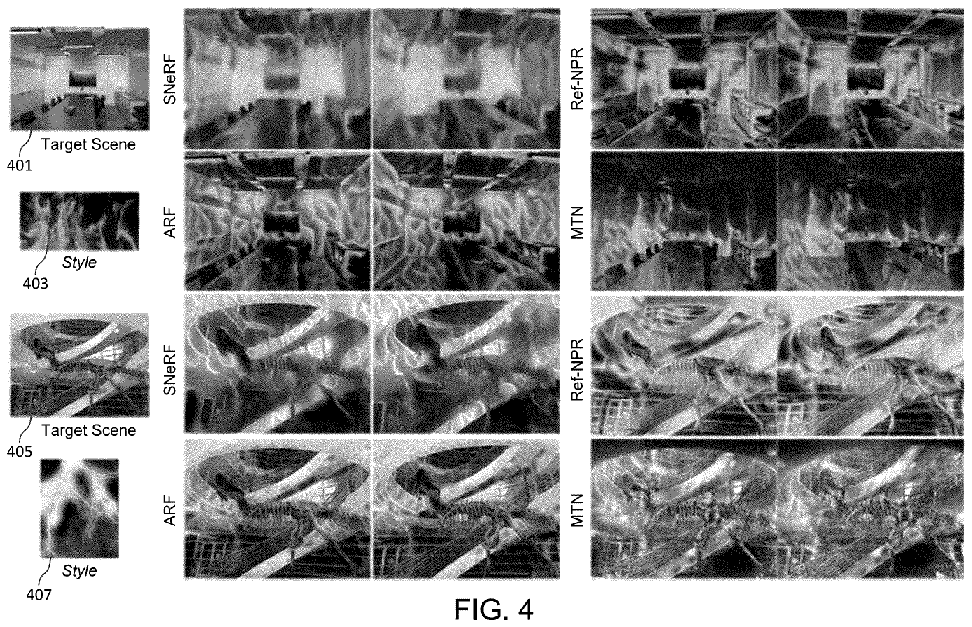

Qualitative comparisons. FIG. 4 illustrates SNeRF, ARF and Ref-NPR. Such results are rendered at a fixed time step with viewpoint changes. In FIG. 4, the present Motion Transfer methods of the exemplary aspects of the present disclosure are compared to ARF, Ref-NPR, and StyleRF. For this comparison, the time input may be fixed at a specific timestep and the viewpoints are varied to ensure that the Motion Transfer network (MTN) of the exemplary aspects of the present disclosure operates similarly to other methods. When stylizing with the other methods, a style image may be selected from the corresponding timestep of the style video to stylize the scenes. In the example of FIG. 4, the style video(s) may be a burning flame style video (e.g., style video 403 (e.g., style video 103)) and a rain style video (e.g., style video 407) applied to a target scene 401 (e.g., target scene 301) and target scene 405 (e.g., target scene 311).

Accordingly, aspects of the present disclosure may achieve a clearer and more accurate style transfer, particularly in terms of color fidelity and shape definition of the given style while past, or existing, works (e.g., ARF, Ref-NPR, and StyleRF) map similar colors and vague patterns onto the 3D scene. This demonstrates that the proposed training strategy of the Motion Transfer network of the exemplary aspects of the present disclosure effectively captures distinct elements of each frame at particular timesteps. Additionally, proposed color transfer and position-aware matching of the Motion Transfer network of the exemplary aspects of the present disclosure allows stylization to reflect the given style more faithfully. In some examples, the Motion Transfer network of the exemplary aspects of the present disclosure may be implemented, and/or executed, by a component/model (e.g., AI video generation model 47, AI video generation model 98, machine learning model(s) 1130).

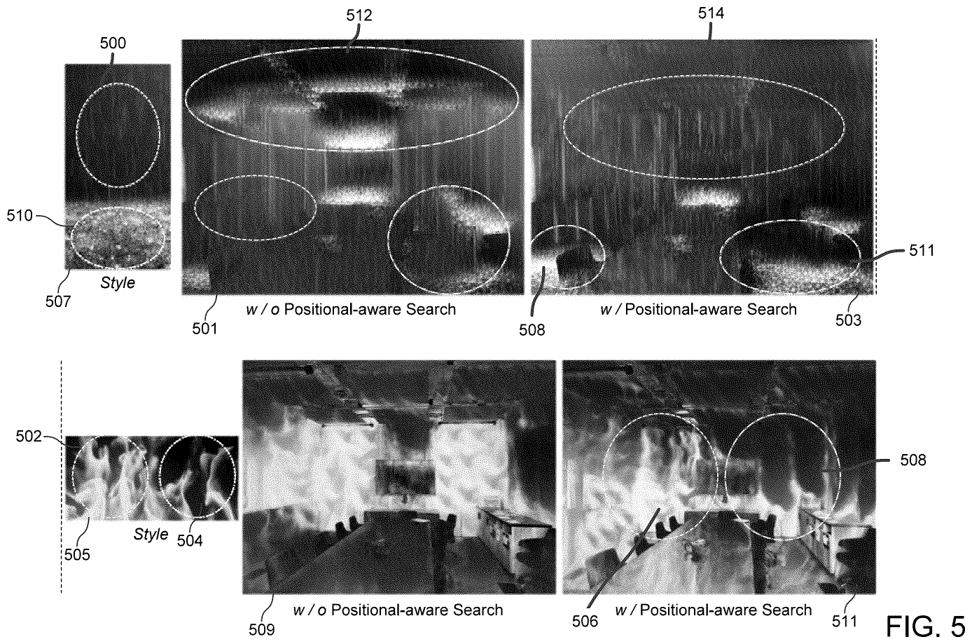

FIG. 5 illustrates ablations of position-aware nearest search. With positional encoding, the spatial distribution of the stylized scene more closely resembles the style reference and natural motion. In FIG. 5, the results with and without the proposed position-aware nearest matching scheme are compared. When stylizing a scene using a video of rain (e.g., style video 507), the objective is to achieve a more realistic effect. The style video 507 may have a rain motion style 500 and a splash motion style 510. In this manner for example, the top part 514 of the 3D scene 503 may depict rainfall (based on applying rain motion style 500), while the bottom part(s) (e.g., bottom parts 508, 511) may display droplets and splashes (based on applying splash motion style 510) from rain impacting surfaces. Without positional search, the splashes of the scene 501 are predominantly located at the top 512 of the scene, diminishing the realism of the intended motion. However, with positional search applied, the splashes of the scene 503 are accurately positioned on the floor (e.g., bottom parts 508, 511) of the scene 503, enhancing the realistic nature of the motion associated with the rain style video (e.g., style video 507).

In the right example of the burning flame style video (e.g., style video 505), the left part 502 of the fire image displays dense and high flames while the right part 504 shows sparse and lower flames. This variation is accurately captured in the results of the scene 511 with position-aware search which has dense and high flames in the left part 506 of the scene 511 and lower flames in the right part 508 of the scene 511. On the other hand, without positional search applied, the flames of the scene 509 are about uniformly dense, which inaccurately depicts the intended motion and diminishes the realism of the intended motion of the burning style video (e.g., style video 505). By incorporating positional information through positional encoding, the effects are rendered more realistically, closely resembling the natural motion observed in the reference video. In the examples of FIG. 5, the scenes 501, 503, 509, 511 may be examples of 3D scenes (e.g., 3D video scenes).

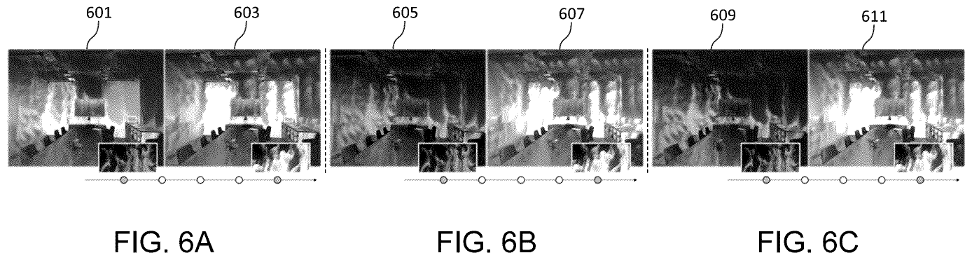

Iterative color transfer. FIGS. 6A, 6B, and 6C illustrate ablations of iterative color transfer. Without keyframe interpolation, the resulting style may become a mixture of multiple frames and may fail to effectively model appearance variations. Adding keyframe interpolation and iterative transfer to frames (e.g., video frames) may result in distinct and clearer colors. Thus, in FIGS. 6A, 6B, and 6C, the effectiveness of the proposed color transfer strategy is demonstrated. In the leftmost example of scenes 601, 603 (e.g., video frames), results were computed/determined without employing the matrix interpolation technique (e.g., without keyframe interpolation). The transformation matrix A is estimated using a union set of colors from all the keyframes, rather than being computed/determined independently for each specific timestep. When the style video exhibits significant appearance variations over time, this approach fails to accurately model the proper color distribution. This results in an improper mix of red and white colors in the scenes 601 and 603, even though the style image at that time may contain only red. By computing/determining the transformation matrices separately for each keyframe and interpolating them, associated with the process of FIG. 6B, for specific timesteps, colors may be accurately modeled despite significant differences between frames in a style video. Finally, by integrating the color transfer process of FIG. 6C iteratively during training, clearer and smoother results with reduced aliasing may be achieved.

With further regards to FIG. 6B, in performing the keyframe interpolation, a component/model (e.g., AI video generation component 47, AI video generation component 98, machine learning model(s) 1130) may compute/determine separate color-transfer statistics (e.g., means and covariances) for the style images/videos at different timesteps and may determine a corresponding color-transfer matrix for each keyframe(s) (e.g., scenes 605, 607). These matrices may then be interpolated for intermediate timesteps. In this manner, the component/model may represent more accurate color associated with each timestep(s). As such, in an instance in which a style video (e.g., style video 103) changes from red color to white color, the corresponding 3D scene(s) may represent more similar red color when the 3D scene(s) should represent red color while representing more similar white color when the 3D scene(s) should represent white color. Referring again to FIG. 6C, regarding the iterative color transfer process, the iterative color transfer process may be applied by the component/model (e.g., AI video generation component 47, AI video generation component 98, machine learning model(s) 1130) to iteratively refine the color-transfer matrices at the keyframes such that the color statistics of the stylized frames more closely match those of the corresponding style frames (e.g., style video frames). This process may be repeated multiple times until color consistency across the keyframes is achieved. As such, the scenes 609 and 611 of FIG. 6C may show more vivid color in relation to the color of the scenes 605 and 607 of FIG. 6B.

TABLE 1
Cross-view consistency of some recent 3D style
transfer methods in relation to the MTN.

| SNeRF | ARF | Ref-NPR | MTN |
|---|---|---|---|
| 0.018 | 0.013 | 0.015 | 0.010 |

TABLE 2
User study reporting the average rankings
according to user preferences.

| SNeRF | ARF | Ref-NPR | MTN |
|---|---|---|---|
| 3.27 | 2.27 | 2.59 | 1.86 |

### Quantitative Results.

Table 1 compares the long-range cross-view consistency of the present method against recent methods across eight stylized scenes, averaging the results. The time input may be fixed, and the evaluated results rendered with viewpoint changes only. As shown in Table 1, the present method (e.g., the Motion Transfer network (MNT) of the exemplary aspects) achieves the highest consistency. This further demonstrates that the goal of incorporating motion may not introduce any disadvantages in terms of view consistency, compared to previous or existing 3D style transfer methods. For example, a cross-view consistency value of 0.010 denotes that the approach of the exemplary aspects of the present disclosure achieves the lowest error among the compared methods, indicating the highest consistency when rendering the scene from different viewpoints.

In Table 2, the preferences of 20 users are presented and shown as rankings for four methods across eight different scene-style pairs. The present method (e.g., the Motion Transfer network of the exemplary aspects) achieved the highest average ranking compared to others. Additionally, feedback was obtained regarding the impact of adding motion as opposed to using a fixed style. Notably, 70% of users reported that motion enhances the stylistic identity. These results demonstrate significant potential of the present method in broadening the applicability of motion transfer. For example, an average ranking score value of 1.86 denotes that the approach of the exemplary aspects of the present disclosure received the highest preference among users, as lower ranking values indicate better user-perceived quality compared to the higher scores of the existing approaches being compared.

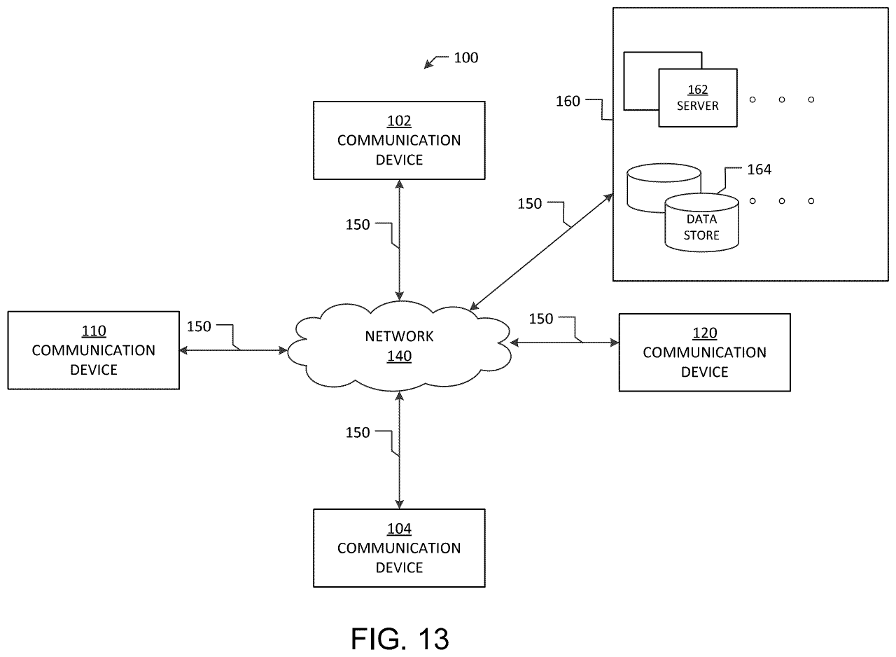

Multi-style interpolation. A significant drawback of optimization-based style transfer is that it may require an individual training stage for each style reference to produce a stylized output. Moreover, in practical scenarios, this may necessitate maintaining multiple 3D models to accommodate various styles. To mitigate this issue, the motion transfer application or algorithm (e.g., the Algorithm 1/Application 1) may allow the integration of multiple style references into a single model, facilitating free interpolation between them. Initially, upon receiving the desired style images, a video may be created by setting these images as keyframes and filling the intermediate frames with the results of interpolating these keyframes. Subsequently, the network (e.g., system 100 of FIG. 13) may be stylized using this video reference.

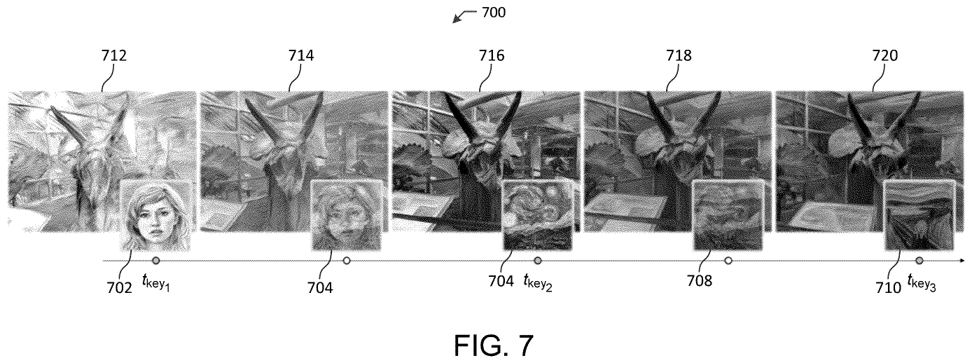

FIG. 7 illustrates an example of multi-style interpolation. By using a style video as an interpolation of multiple style images, multiple styles may be injected into a single network (e.g., network 100), allowing for seamless interpolation between the multiple style images.

A significant drawback of some existing optimization-based style transfer techniques is that they may require an individual training stage for each style reference to produce a stylized output. Moreover, in some scenarios, this may necessitates maintaining multiple 3D models to accommodate various styles. To mitigate this issue, the Motion Transfer network of the exemplary aspects of the present disclosure may utilize a motion transfer application (e.g., Application 1/Algorithm 1) that allows the integration of multiple style references into a single model (e.g., machine learning model(s) 1130), facilitating free interpolation between the multiple style references. As referred to herein, “style references” may refer to multiple style images that each represent a different desired style. These style images may be used as keyframes to create/generate an interpolated style video(s), in which the intermediate video frames may be generated by interpolating between the style images. This constructed style video may then be used as input to the Motion Transfer system to allow the model to support multiple styles within a single trained network (e.g., machine learning model(s) 1130). Initially, upon receiving the desired style images, the Motion Transfer network of the exemplary aspects may create/generate a video by setting these images as keyframes and filling the intermediate frames with the results of interpolating these keyframes. As referred to herein, “style images” may refer to individual 2D reference images that each represent a distinct desired style. These images may not be a style video themselves. Rather, these style images may be used as keyframes from which a synthetic style video may be constructed by interpolating the frames between them.

Subsequently, the Motion Transfer network may stylize a sequence of rendered frames—one per timestep—using the style reference video, thereby producing a stylized video when the resulting frames are combined.

FIG. 7 further showcases the results from a single model (e.g., machine learning model(s) 1130) rendered at different time steps (e.g., t_{key1}, t_{key2}, t_{key3}). The present method's capability to model global appearance changes enables models to freely convert the appearance corresponding to each style image (e.g., style images 702, 704, 706, 708, 710) and smoothly interpolate between the style images. This approach underscores the potential benefits of the method, such as avoiding per-style optimization and eliminating the need for multiple 3D models. In this manner, the Motion Transfer network of the exemplary aspects may use these style images (e.g., style images 702, 704, 706, 708, 710) as keyframes to construct an interpolated style video that may then be applied to stylize the 3D scene. As such, by utilizing a single model (e.g., machine learning model(s) 1130), the Motion Transfer network may represent multiple styles within a single 3D scene by constructing an interpolated style video in which each timestep(s) encodes a different blend of the provided style images. This may enable the model (e.g., machine learning model(s) 1130) to generate stylized outputs for multiple styles without optimization, meaning without requiring separate training or fine-tuning for each individual style. As such, the multi-style interpolation approach/technique of FIG. 7, may enable the MTN to create a video (e.g., style video 700) including a sequence of different style images 702, 704, 706, 708, 710 (e.g., artistic images) applied to scenes 712, 714, 716, 718, 720 (e.g., video frames) of a target scene. In this manner, the Motion Transfer network of the exemplary aspects may utilize the video 700 to generate another/different style video based on selecting a timestep(s) of the video 700 at a test time, and utilizing the video 700 to stylize another current frame or scene(s) based on the current frame.

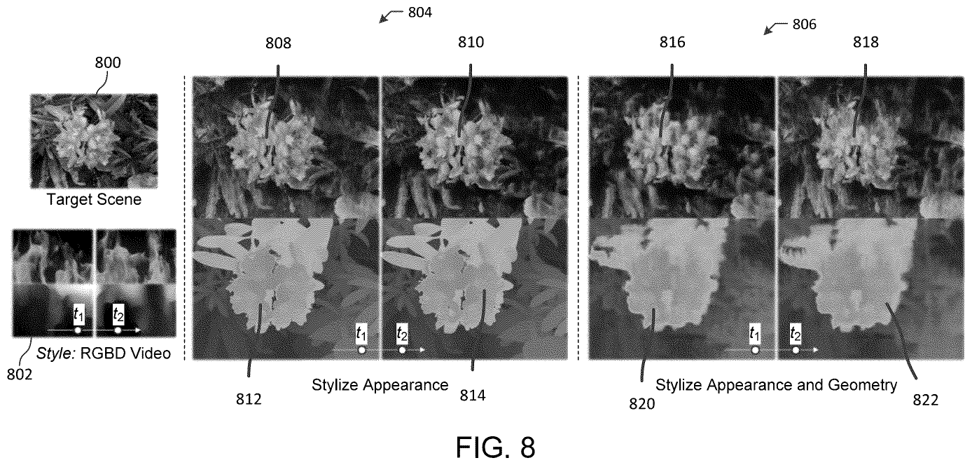

FIG. 8 illustrates geometry stylization in accordance with aspects discussed herein. With an estimated depth video along with a style video, the present method may also model the dynamics of geometric variations during stylization. The depth video may be a Red-Green-Blue-Depth (RGBD) video having color and a depth map. For instance, the RGBD video may include image and/or video content that may include color (e.g., RGB) content with spatial depth data. This may enable/provide a better understanding of a scene (e.g., 3D scene) by providing color and distance content for each of the pixels of the image/video data. FIG. 8 illustrates the method's compatibility with other approaches, and stylizing both shapes and appearances of target 3D scenes. During the motion transfer process, for example, videos of estimated depth images may be utilized along with RGB style videos (e.g., style RGBD video 802) to optimize the scene's (e.g., target scene 800) shape. When only the appearance is stylized (e.g., left figure image(s) 804), the motion may be confined within the object's (e.g., objects 808, 810, 812, 814) fixed boundaries, which may result in a less realistic effect, as the nature of burning (e.g., associated with the burn style video (e.g., style RGBD video 802)) may involve the disruption of these boundaries. In this regard, by applying the style RGBD video 802 to the target scene 800 such may cause generation of the image(s) 804 having a color (e.g., the appearance) of the objects 808, 810, 812, 814 stylized. On the other hand, the geometry of the objects 808, 810, 812, 814 may be unchanged. However, when the shape is also updated in an instance of applying the style RGBD video 802 (e.g., right figure image(s) 806), the object (e.g., objects 816, 818, 820, 822) boundaries fluctuate which may cause the geometries of objects 816, 818, 820, 822 to be changed), allowing for a broader representation of motion. In this regard, the geometries of the flower associated with the objects 816, 818, 820, 822 may be changed as well as the color of the objects 816, 818, 820, 822. For example, the color may be changed from a pink or red color flower in target scene 800 to an orange or brown color in objects 816, 818 and yellow color in objects 820, 822. This may enhance both the realism and dynamics of the scene (e.g., target scene 800).

In various examples, a trade-off typically exists between representing stylistic identity and preserving the original content structure. Present techniques may model the dynamics of elements to enhance this stylistic identity, though this may, in some but not all instances, result in a partial loss of content. For instance, effectively modeling the motion of burning fire may require the flames to oscillate back and forth across object boundaries that may be beneficial for maintaining content structure.

To accurately capture this movement, each stylized result at a specific timestep may more closely and strongly reflect the corresponding style image. Otherwise, the resultant motion may lack accuracy. This effort to represent the accurate nature of motion inevitably may lead to the sacrifice of original content while achieving a more dynamic and energetic stylization. Thus, in addition to maximizing dynamics, it is important to find a proper balance among stylistic identity, the level of dynamics, and original structure.

Additionally, the choice of HexPlane as a dynamic NeRF representation confines experiments to bounded scenes, and may serve as a starting point for extending applicability to different scenes, including 360° unbounded scenes. Accordingly, aspects of the present disclosure introduce Motion Transfer, a novel method that stylizes a 3D static scene using a 2D video to transform it into a 4D dynamic scene. The carefully designed style loss successfully captures the continuous flow of motion and appearance extracted from the video effectively applies these attributes to the target 3D scene. The position-aware search and iterative color transfer further enhance the aesthetic quality of the stylization and accurately reflect the color dynamics of the style source. Accordingly, through extensive experiments, motion transfer systems, methods, and techniques have significant potential to enable visually pleasing and dynamic stylization, thereby broadening the applicability of style transfer.

### Exemplary Communication Device

FIG. 9 illustrates a block diagram of an exemplary hardware/software architecture of a communication device such as, for example, user equipment (UE) 30. In some exemplary aspects, the UE 30 may be any of communication devices 105, 110, 115, 120. In some exemplary aspects, the UE 30 may be a computer system such as for example a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 9, the UE 30 (also referred to herein as node 30) may include a processor 32, non-removable memory 44, removable memory 46, a speaker/microphone 38, a keypad 40, a display, touchpad, and/or user interface(s) 42, a power source 48, a global positioning system (GPS) chipset 50, other peripherals 52, and an artificial intelligence (AI) video generation component 47. In some exemplary aspects, the display, touchpad, and/or user interface(s) 42 may be referred to herein as display/touchpad/user interface(s) 42. The display/touchpad/user interface(s) 42 may include a user interface capable of presenting one or more content items and/or capturing input of one or more user interactions/actions associated with the user interface. The power source 48 may be capable of receiving electric power for supplying electric power to the UE 30. For example, the power source 48 may include an alternating current to direct current (AC-to-DC) converter allowing the power source 48 to be connected/plugged to an AC electrical receptable and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or removable memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, (e.g., non-removable memory 44 and/or removable memory 46) as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

In some exemplary aspects, the AI generation video component 47 may access, or capture, one or more images and/or one or more videos and may apply a style video to the one or more images and/or one or more videos to apply a dynamic motion of the style video to a video(s) generated based on the accessed or captured images that may be connected together (e.g., connected/stitched frames of the images forming the video). The AI generation video component 47 may also apply a style video to the accessed or captured one or more videos to apply the dynamic motion of the style video to the accessed/captured videos, as described more fully above.

### Exemplary Computing System

FIG. 10 is a block diagram of an exemplary computing system 1000. In some exemplary embodiments, the network device 160 may be a computing system 1000. The computing system 1000 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 1000 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 1000 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 1000 may contain peripherals controller 83 responsible for communicating instructions from CPU 91 to peripherals, such as printer 94, keyboard 84, mouse 95, and disk drive 85.

Display 86, which is controlled by display controller 96, may be used to display visual output generated by computing system 1000. Such visual output may include text, graphics, animated graphics, and video. The display 86 may also include, or be associated with a user interface. The user interface may be capable of presenting one or more content items and/or capturing input of one or more user interactions associated with the user interface. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

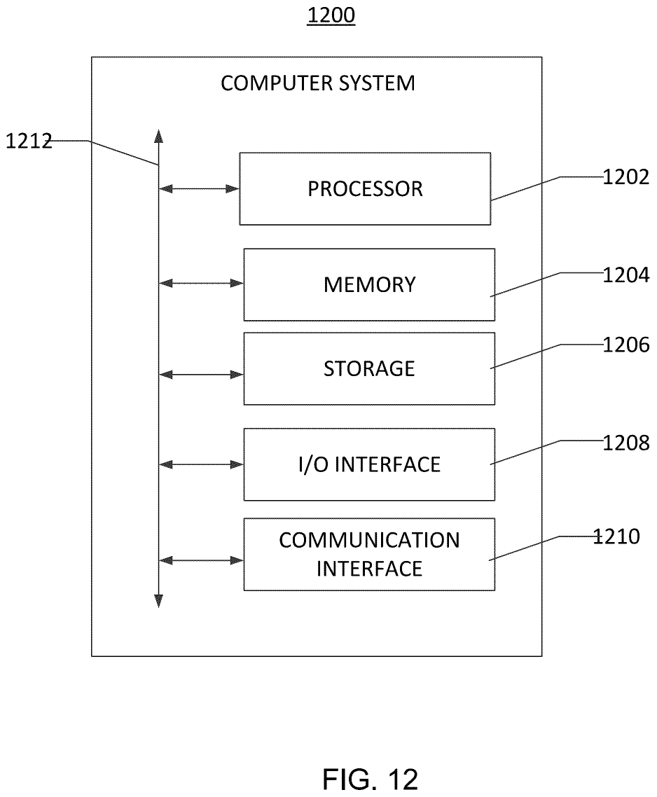

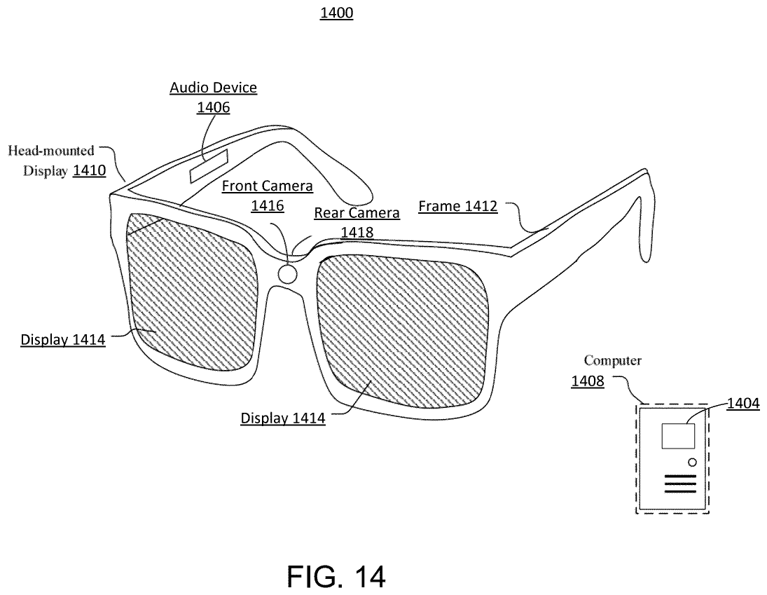

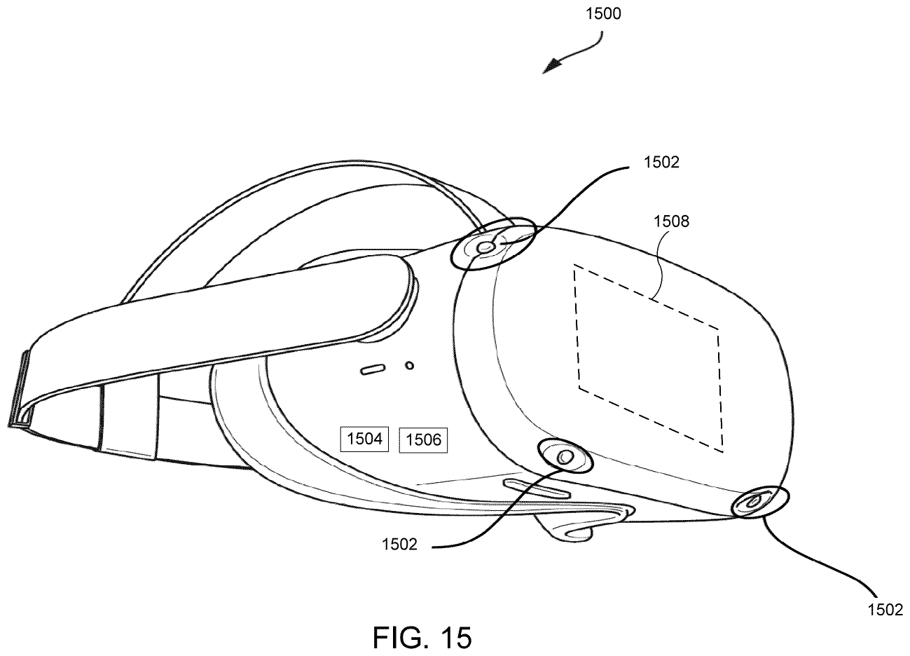

In some exemplary aspects, the computing system 1000 may include an AI generation video component 98 which may access, or capture, one or more images and/or one or more videos and may apply a style video to the one or more images and/or one or more videos to apply a dynamic motion of the style video to a video(s) generated based on the accessed or captured images that may be connected together (e.g., connected/stitched frames of the images forming the video). The AI generation video component 98 may also apply a style video to the accessed or captured one or more videos to apply the dynamic motion of the style video to the accessed/captured videos, as described more fully above. In some examples, the AI generation video component 98 may provide the generated video(s) having the dynamic motion of the style video to a communication device (e.g., UE 30, computing system 1200) to enable the communication device to present the generated video, having the applied motion of the style video, via a display device and/or a user interface (e.g., display/touchpad/user interface(s) 42 of FIG. 9, I/O interface 1208 of FIG. 12, display 1414 of FIG. 14, HMD 1500 of FIG. 15, etc.).

Further, computing system 1000 may contain communication circuitry, such as for example a network adaptor 97, that may be used to connect computing system 1000 to an external communications network, such as network 12 of FIG. 9, to enable the computing system 1000 to communicate with other nodes (e.g., UE 30) of the network.

### Exemplary Machine Leaning Framework

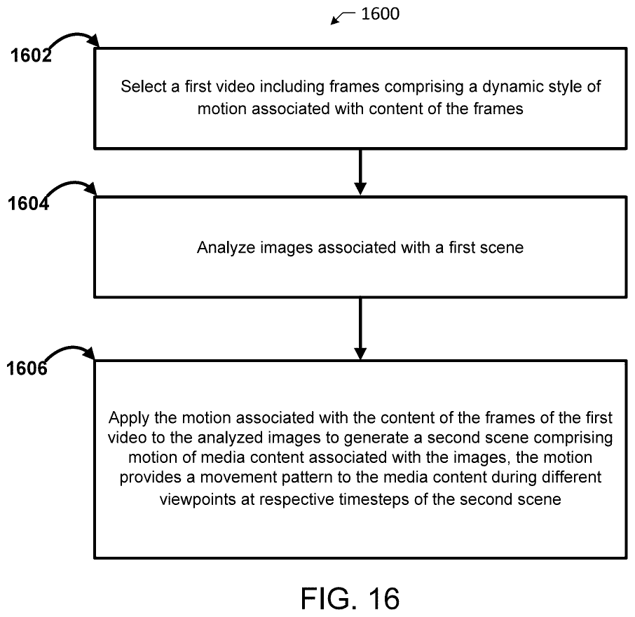

FIG. 11 illustrates an example of a machine learning framework 1100 including machine learning model(s) 1130 and a training database 1150, in accordance with one or more examples of the present disclosure. The training database 1150 may store training data 1120. In some examples, the machine learning framework 1100 may be hosted locally in a computing device or hosted remotely. By utilizing the training data 1120 of the training database 1150, the machine learning framework 1100 may train the machine learning model(s) 1130 to perform one or more functions, described herein, of the machine learning model(s) 1130. In some examples, the machine learning model(s) 1130 may be stored in a computing device. For example, the machine learning model(s) 1130 may be embodied within a communication device (e.g., UE 30). In some examples, the machine learning model(s) 1130 may be stored in another computing device. For example, the machine learning model(s) 1130 may be embodied within another communication device (e.g., HMD 1410, HMD 1500, computing system 1000, computing system 1200). In some other examples, the machine learning model(s) 1110 may be embodied within another device (e.g., computing system 1000, computing system 1200). Additionally, the machine learning model(s) 1110 may be processed by one or more processors (e.g., processor 32 of FIG. 9, coprocessor 81 of FIG. 10, processor 1202 of FIG. 12, controller 1404 of FIG. 14, processor 1504 of FIG. 15). In some examples, the machine learning model(s) 1130 may be associated with operations (or performing operations) of FIG. 16. In some other examples, the machine learning model(s) 1130 may be associated with other operations. In some examples, the machine learning model(s) 1130 may be an example of the AI video generation component 47, and/or the AI video generation component 98.

In an example, the training data 1120 may include attributes of thousands of objects. For example, the objects may be posters, brochures, billboards, menus, goods (e.g., packaged goods), books, groceries, Quick Response (QR) codes, smart home devices, home and outdoor items, household objects (e.g., furniture, kitchen appliances, etc.) and any other suitable objects. In some other examples, the objects may be smart devices (e.g., UEs 30, communication devices 105, 110, 115, 120), persons (e.g., users), newspapers, articles, flyers, pamphlets, signs, cars, content items (e.g., messages, notifications, images, videos, audio), and/or the like. Attributes may include, but are not limited to, the size, shape, orientation, position/location of the object(s), etc. The training data 1120 employed by the machine learning model(s) 1130 may be fixed or updated periodically. Alternatively, the training data 1120 may be updated in real-time based upon the evaluations performed by the machine learning model(s) 1130 in a non-training mode. This may be illustrated by the double-sided arrow connecting the machine learning model(s) 1130 and stored training data 1120. Some other examples of the training data 1120 may include, but are not limited to, items of content determined as being associated with a network (e.g., the Internet, a social network, etc.). These items of content may be provided as a subset of the training data 1120 to the training database 1150 and may be utilized, in part, to pre-train, and/or train in real-time, the machine learning model(s) 1130.

In some examples, the training dataset (e.g., training data 1120) may include, but is not limited to, two types of multi-media content. The first type/set of multimedia content may be images that may include multiple captured images of a target real-world 3D scene from various viewpoints. The second type/set of multi-media content may include 2D video frames that may represent a desired style of motion. In this regard, the training data 1120 may include one or more style videos (e.g., style videos 103, 403, 407, 505, 507, style RGBD video 802, etc.). The machine learning model(s) 1130 may be initially trained to reconstruct the real-world 3D scene using the first type/set of images. Once the machine learning model(s) 1130 is initially trained (e.g., the baseline machine learning model(s) 1130), the machine learning model(s) 1130 may be fine-tuned using both datasets such as for example the first type/set and the second type/set. This fine-tuning process may enable the machine learning model(s) 1130 to overlay the motion style from the video (e.g., the video frame(s)) onto the reconstructed 3D scene, seamlessly integrating the dynamic motion into the real-world context.

### Exemplary Computer System

FIG. 12 illustrates an example computer system 1200. In examples, one or more computer systems 1200 perform one or more steps of one or more methods described or illustrated herein. In particular embodiments, one or more computer systems 1200 provide functionality described or illustrated herein. In examples, software running on one or more computer systems 1200 performs one or more steps of one or more methods described or illustrated herein or provides functionality described or illustrated herein. Examples include one or more portions of one or more computer systems 1200. Herein, reference to a computer system may encompass a computing device, and vice versa, where appropriate. Moreover, reference to a computer system may encompass one or more computer systems, where appropriate.

This disclosure contemplates any suitable number of computer systems 1200. This disclosure contemplates computer system 1200 taking any suitable physical form. As example and not by way of limitation, computer system 1200 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1200 may include one or more computer systems 1200; be unitary or distributed; span multiple locations; span multiple machines; span multiple data centers; or reside in a cloud, which may include one or more cloud components in one or more networks. Where appropriate, one or more computer systems 1200 may perform without substantial spatial or temporal limitation one or more steps of one or more methods described or illustrated herein. As an example, and not by way of limitation, one or more computer systems 1200 may perform in real time or in batch mode one or more steps of one or more methods described or illustrated herein. One or more computer systems 1200 may perform at different times or at different locations one or more steps of one or more methods described or illustrated herein, where appropriate.

In examples, computer system 1200 includes a processor 1202, memory 1204, storage 1206, an input/output (I/O) interface 1208, a communication interface 1210, and a bus 1212. Although this disclosure describes and illustrates a particular computer system having a particular number of particular components in a particular arrangement, this disclosure contemplates any suitable computer system having any suitable number of any suitable components in any suitable arrangement.

In examples, processor 1202 includes hardware for executing instructions, such as those making up a computer program. As an example and not by way of limitation, to execute instructions, processor 1202 may retrieve (or fetch) the instructions from an internal register, an internal cache, memory 1204, or storage 1206; decode and execute them; and then write one or more results to an internal register, an internal cache, memory 1204, or storage 1206. In particular embodiments, processor 1202 may include one or more internal caches for data, instructions, or addresses. This disclosure contemplates processor 1202 including any suitable number of any suitable internal caches, where appropriate. As an example, and not by way of limitation, processor 1202 may include one or more instruction caches, one or more data caches, and one or more translation lookaside buffers (TLBs). Instructions in the instruction caches may be copies of instructions in memory 1204 or storage 1206, and the instruction caches may speed up retrieval of those instructions by processor 1202. Data in the data caches may be copies of data in memory 1204 or storage 1206 for instructions executing at processor 1202 to operate on; the results of previous instructions executed at processor 1202 for access by subsequent instructions executing at processor 1202 or for writing to memory 1204 or storage 1206; or other suitable data. The data caches may speed up read or write operations by processor 1202. The TLBs may speed up virtual-address translation for processor 1202. In particular embodiments, processor 1202 may include one or more internal registers for data, instructions, or addresses. This disclosure contemplates processor 1202 including any suitable number of any suitable internal registers, where appropriate. Where appropriate, processor 1202 may include one or more arithmetic logic units (ALUs); be a multi-core processor; or include one or more processors 1202. Although this disclosure describes and illustrates a particular processor, this disclosure contemplates any suitable processor.

In examples, memory 1204 includes main memory for storing instructions for processor 1202 to execute or data for processor 1202 to operate on. As an example, and not by way of limitation, computer system 1200 may load instructions from storage 1206 or another source (such as, for example, another computer system 1200) to memory 1204. Processor 1202 may then load the instructions from memory 1204 to an internal register or internal cache. To execute the instructions, processor 1202 may retrieve the instructions from the internal register or internal cache and decode them. During or after execution of the instructions, processor 1202 may write one or more results (which may be intermediate or final results) to the internal register or internal cache. Processor 1202 may then write one or more of those results to memory 1204. In particular embodiments, processor 1202 executes only instructions in one or more internal registers or internal caches or in memory 1204 (as opposed to storage 1206 or elsewhere) and operates only on data in one or more internal registers or internal caches or in memory 1204 (as opposed to storage 1206 or elsewhere). One or more memory buses (which may each include an address bus and a data bus) may couple processor 1202 to memory 1204. Bus 1212 may include one or more memory buses, as described below. In examples, one or more memory management units (MMUs) reside between processor 1202 and memory 1204 and facilitate accesses to memory 1204 requested by processor 1202. In particular embodiments, memory 1204 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1204 may include one or more memories 1204, where appropriate. Although this disclosure describes and illustrates particular memory, this disclosure contemplates any suitable memory.

In examples, storage 1206 includes mass storage for data or instructions. As an example, and not by way of limitation, storage 1206 may include a hard disk drive (HDD), a floppy disk drive, flash memory, an optical disc, a magneto-optical disc, magnetic tape, or a Universal Serial Bus (USB) drive or a combination of two or more of these. Storage 1206 may include removable or non-removable (or fixed) media, where appropriate. Storage 1206 may be internal or external to computer system 1200, where appropriate. In examples, storage 1206 is non-volatile, solid-state memory. In particular embodiments, storage 1206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1206 taking any suitable physical form. Storage 1206 may include one or more storage control units facilitating communication between processor 1202 and storage 1206, where appropriate. Where appropriate, storage 1206 may include one or more storages 1206. Although this disclosure describes and illustrates particular storage, this disclosure contemplates any suitable storage.

In examples, I/O interface 1208 includes hardware, software, or both, providing one or more interfaces for communication between computer system 1200 and one or more I/O devices. Computer system 1200 may include one or more of these I/O devices, where appropriate. One or more of these I/O devices may enable communication between a person and computer system 1200. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1208 for them. Where appropriate, I/O interface 1208 may include one or more device or software drivers enabling processor 1202 to drive one or more of these I/O devices. I/O interface 1208 may include one or more I/O interfaces 1208, where appropriate. Although this disclosure describes and illustrates a particular I/O interface, this disclosure contemplates any suitable I/O interface.

In examples, communication interface 1210 includes hardware, software, or both providing one or more interfaces for communication (such as, for example, packet-based communication) between computer system 1200 and one or more other computer systems 1200 or one or more networks. As an example, and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1210 for it. As an example, and not by way of limitation, computer system 1200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1200 may include any suitable communication interface 1210 for any of these networks, where appropriate. Communication interface 1210 may include one or more communication interfaces 1210, where appropriate. Although this disclosure describes and illustrates a particular communication interface, this disclosure contemplates any suitable communication interface.

In particular embodiments, bus 1212 includes hardware, software, or both coupling components of computer system 1200 to each other. As an example and not by way of limitation, bus 1212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1212 may include one or more buses 1212, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, computer readable medium or any suitable combination of two or more of these, where appropriate. A computer-readable non-transitory storage medium may be volatile, non-volatile, or a combination of volatile and non-volatile, where appropriate.

### Exemplary System Architecture

Reference is now made to FIG. 13, which is a block diagram of a system according to exemplary embodiments. As shown in FIG. 13, the system 100 may include one or more communication devices 102, 110, 104 and 120 and a network device 160. Additionally, the system 100 may include any suitable network such as, for example, network 140. In some examples, the network 140 may be a Metaverse network. In other examples, the network 140 may be any suitable network capable of provisioning content and/or facilitating communications among entities within, or associated with the network. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 102, 110, 104 and 120 to network 140, network device 160 and/or to each other. This disclosure contemplates any suitable links 150. In some exemplary embodiments, one or more links 150 may include one or more wireline (such as for example Digital Subscriber Line (DSL) or Data Over Cable Service Interface Specification (DOKSAS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary embodiments, one or more links 150 may each include an ad hoc network, an intranet, an extranet, a VPN, a LAN, a WLAN, a WAN, a WAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 102, 110, 104, 120 may be electronic devices including hardware, software, or embedded logic components or a combination of two or more such components and capable of carrying out the appropriate functionalities implemented or supported by the communication devices 102, 110, 104, 120. As an example, and not by way of limitation, the communication devices 102, 110, 104, 120 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 102, 110, 104, 120 may enable one or more users to access network 140. The communication devices 102, 110, 104, 120 may enable a user(s) to communicate with other users at other communication devices 102, 110, 104, 120.

Network device 160 may be accessed by the other components of system 100 either directly or via network 140. As an example and not by way of limitation, communication devices 102, 110, 104, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 102, 110, 104, 120 and/or another system (e.g., a third-party system) to manage, retrieve, modify, add, or delete, the information stored in data store 164.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or to allow users to interact with these entities through an application programming interfaces (API) or other communication channels.

It should be pointed out that although FIG. 13 shows one network device 160 and four communication devices 102, 110, 104 and 120, any suitable number of network devices 160 and communication devices 102, 110, 104 and 120 may be part of the system of FIG. 13 without departing from the spirit and scope of the present disclosure.

### Exemplary Artificial Reality System

FIG. 14 illustrates an example artificial reality system 1400. The artificial reality system 1400 may include a head-mounted display (HMD) 1410 (e.g., smart glasses and/or augmented/virtual reality device) comprising a frame 1412, one or more displays 1414, a computing device 1408 (also referred to herein as computer 1408) and a controller 1404. In some examples, the HMD 1410 may capture content (e.g., images/videos) associated with a real world environment in the field of view of one or more cameras (e.g., cameras 1416, 1418) of the artificial reality system 1400. The displays 1414 may be transparent or translucent allowing a user wearing the HMD 1410 to look through the displays 1414 to see the real world (e.g., real world environment and/or an AR/VR/MR environment) and displaying visual artificial reality content to the user at the same time. The HMD 1410 may include an audio device 1406 (e.g., speakers/microphones) that may provide audio artificial reality content to users. The HMD 1410 may include one or more cameras 1416, 1418 which may capture images and/or videos of environments. In one exemplary embodiment, the HMD 1410 may include a camera(s) 1418 which may be a rear-facing camera tracking movement and/or gaze of a user's eyes.

One of the cameras 1416 may be a forward-facing camera capturing images and/or videos of the environment that a user wearing the HMD 1410 may view. The camera(s) 1416 may also be referred to herein as a front camera(s) 1516. The HMD 1410 may include an eye tracking system to track the vergence movement of the user wearing the HMD 1410. In one exemplary embodiment, the camera(s) 1418 may be the eye tracking system. In some exemplary embodiments, the camera(s) 1418 may be one camera configured to view at least one eye of a user to capture a glint image(s) (e.g., and/or glint signals). The camera(s) 1418 may also be referred to herein as a rear camera(s) 1418. The HMD 1410 may include a microphone of the audio device 1406 to capture voice input from the user. The artificial reality system 1400 may further include a controller 1404 comprising a trackpad and one or more buttons. The controller 1404 may receive inputs from users and relay the inputs to the computing device 1408. The controller 1404 may also provide haptic feedback to one or more users. In some example aspects, the controller 1404 may perform functions/operations as the functions/operations of the AI video generation component 47 and/or the AI video generation component 98. The computing device 1408 may be connected to the HMD 1410 and the controller 1404 through cables or wireless connections. The computing device 1408 may control the HMD 1410 and the controller 1404 to provide the augmented reality content to and receive inputs from one or more users. In some example aspects, the controller 1404 may be a standalone controller or integrated within the HMD 1410. The computing device 1408 may be a standalone host computer device, an on-board computer device integrated with the HMD 1410, a mobile device, or any other hardware platform capable of providing artificial reality content to and receiving inputs from users. In some exemplary aspects, the HMD 1410 may include an artificial reality system/virtual reality system.

### Another Exemplary Artificial Reality System

FIG. 15 illustrates another example of an artificial reality system including a head-mounted display (HMD) 1500, image sensors 1502 mounted to (e.g., extending from) HMD 1500, according to at least one example aspect of the present disclosure. In some examples of the present disclosure, the HMD 1500 may be an example of artificial reality system 1500 and/or HMD 1510. In some example aspects, image sensors 1502 may be mounted on and protruding from a surface (e.g., a front surface, a corner surface, etc.) of HMD 1500. In some exemplary aspects, HMD 1500 may include an artificial reality system/virtual reality system. In an exemplary aspect, image sensors 1502 may include, but are not limited to, one or more sensors (e.g., cameras 1416, 1418, a display 1414, an audio device 1406, etc.), a memory 1506 (e.g., RAM, ROM) and a processor 1504 (e.g., a controller (e.g., controller 1404)). In some example aspects, the processor 1504 may perform functions/operations as the functions/operations of the AI video generation component 47 and/or the AI video generation component 98. In exemplary aspects, a compressible shock absorbing device may be mounted on image sensors 1502. The shock absorbing device may be configured to substantially maintain the structural integrity of image sensors 1502 in case an impact force is imparted on image sensors 1502. In some exemplary embodiments, image sensors 1502 may protrude from a surface (e.g., the front surface) of HMD 1500 so as to increase a field of view of image sensors 1502. In some examples, image sensors 1502 may be pivotally and/or translationally mounted to HMD 1500 to pivot image sensors 1502 at a range of angles and/or to allow for translation in multiple directions, in response to an impact. For example, image sensors 1502 may protrude from the front surface of HMD 1500 so as to give image sensors 1502 at least a 180 degree field of view of objects (e.g., a hand, a user, a surrounding real-world environment, etc.).

The HMD 1500 may further include a display 1508 designed to present visual information based on an artificial reality system application(s) (e.g., VR) and/or AR application(s) as well as mixed reality application(s). Additionally or alternatively, the display 1508 may be coupled (e.g., electrically coupled) to each of the image sensors 1502, and may present visual information in the form of an external environment, as captured by one or more of the image sensors 1502. Using one or more of the image sensors 1502, the HMD 1500 may capture content and/or media in the environment and may present the content/media onto the display 1508.

For purposes of illustration and not of limitation, in the examples of FIG. 14 and FIG. 15, a user may utilize headsets (e.g., HMD 1500), smart glasses (e.g., HMD 1410), or the like to select a style video (e.g., style video 103) having dynamic motion (e.g., the motion of burning fire/flames). In this manner, the user may utilize a component/model (e.g., controller 1404, processor 1504) to create/generate a new video having dynamic motion of the style video such that the user may control their viewpoints while controlling timesteps of the generated new video, which may include a 3D scene of captured content (e.g., images) by the headsets, glasses applying the dynamic motion of the style video. In some examples, the component/model (e.g., controller 1404, processor 1504) may be, or may implement, the AI video generation component 47, the AI video generation component 98, and/or the machine learning model(s) 1130. In an instance in which the user wears the headset (e.g., HMD 1500) or smart glasses (e.g., HMD 1410), for example, the user may view (e.g., via display 1414, display 1508) the captured content of the headset/smart glasses overlaid in content of a video (e.g., 3D video of a scene(s)) of an environment such as a real world environment or an AR/VR/MR environment having the dynamic motion (e.g., burning fire/flames).

FIG. 16 illustrates an example flowchart process 1600 illustrating operations according to an example of the present disclosure. At operation 1602, a device (e.g., UE 30, HMD 1410, HMD 1500) may select a first video including frames comprising a dynamic style of motion associated with content of the frames. The first video may be a style video such as, for example, style video 103 or any other suitable style videos (e.g., style videos 403, 407, 505, 507, style RGBD video 802). At operation 1604, a device (e.g., UE 30, HMD 1410, HMD 1500) may analyze images (e.g., images 105, 107) associated with a first scene.

At operation 1606, a device (e.g., UE 30, HMD 1410, HMD 1500) may apply the motion associated with the content of the frames of the first video to the analyzed images to generate a second scene comprising motion of media content associated with the images. The motion may provide a movement pattern to the media content during different viewpoints at respective timesteps of the second scene. The first video may include a 2D video. The second scene may include a 3D scene video.

The example aspects of the present disclosure may extract a motion style from a reference video including a plurality of frames indicating motion. A position-aware search to capture visual attributes may be applied to extract the motion style. Example aspects may further apply a dynamic radiance fields network to transfer the extracted style of motion to visual content (e.g., video) and may render a stylized scene providing a continuous flow of viewpoint changes over time.

### ALTERNATIVE ASPECTS

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, computer readable medium or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed:

1. A method comprising:
selecting a first video including frames comprising a dynamic style of motion associated with content of the frames;
analyzing images associated with a first scene; and
applying the motion associated with the content of the frames of the first video to the analyzed images to generate a second scene comprising motion of media content associated with the images, the motion provides a movement pattern to the media content during different viewpoints at respective timesteps of the second scene.

2. The method of claim 1, further comprising:
applying a color of the content of the frames to a color of the media content such that the media content of the second scene comprises the color of the content of the frames.

3. The method of claim 1, wherein:
the selecting further comprises selecting the first video from among a plurality of videos comprising other dynamic styles of motions associated with data items of the plurality of videos.

4. The method of claim 1, wherein:
the first video comprises a two-dimensional (2D) video; and
the second scene comprises a three-dimensional (3D) scene.

5. The method of claim 1, wherein:
the analyzed images are captured by a head mounted display device; and
the second scene is presented by the head mounted display device.

6. The method of claim 5, further comprising:
presenting, by the head mounted display device, the second scene in a virtual reality environment, an augmented reality environment, or a mixed reality environment.

7. The method of claim 1, wherein:
the frames of the first video are matched with frames associated with a second video of the second scene, associated with the analyzed images, at corresponding timesteps of the first video and the second video.

8. The method of claim 1, further comprising:
extracting position based features of the motion of the content of the frames to apply other motion at a position of the content of the frames in a same corresponding position of the media content of the second scene.

9. The method of claim 1, wherein the selecting the first video comprises selecting, by a first device, the first video based on a determined type of content items of the analyzed images.

10. The method of claim 1, wherein the selecting the first video comprises receiving an indication of a selection by a user of the first video.

11. The method of claim 1, further comprising:
adjusting, based on depth information of the first video, a geometry of the media content presented during the second scene.

12. An apparatus comprising:
one or more processors; and
at least one memory storing instructions, that when executed by the one or more processors, cause the apparatus to:
select a first video including frames comprising a dynamic style of motion associated with content of the frames;
analyze images associated with a first scene; and
apply the motion associated with the content of the frames of the first video to the analyzed images to generate a second scene comprising motion of media content associated with the images, the motion provides a movement pattern to the media content during different viewpoints at respective timesteps of the second scene.

13. The apparatus of claim 12, wherein when the one or more processors further execute the instructions, the apparatus is configured to:
apply a color of the content of the frames to a color of the media content such that the media content of the second scene comprises the color of the content of the frames.

14. The apparatus of claim 12, wherein when the one or more processors further execute the instructions, the apparatus is configured to:
perform the select the first video by selecting the first video from among a plurality of videos comprising other dynamic styles of motions associated with data items of the plurality of videos.

15. The apparatus of claim 12, wherein:
the first video comprises a two-dimensional (2D) video; and
the second scene comprises a three-dimensional (3D) scene.

16. The apparatus of claim 12, wherein:
the apparatus comprises a head mounted display device configured to:
capture the analyzed images; and
present, by a display of the head mounted display device, the second scene.

17. The apparatus of claim 16, wherein when the one or more processors further execute the instructions, the apparatus is configured to:
present, by the head mounted display device, the second scene in a virtual reality environment, an augmented reality environment, or a mixed reality environment.

18. The apparatus of claim 12, wherein when the one or more processors further execute the instructions, the apparatus is configured to:
match the frames of the first video with frames associated with a second video of the second scene, associated with the analyzed images, at corresponding timesteps of the first video and the second video.

19. A non-transitory computer-readable medium storing instructions that, when executed, cause:
selecting a first video including frames comprising a dynamic style of motion associated with content of the frames;
analyzing images associated with a first scene; and
applying the motion associated with the content of the frames of the first video to the analyzed images to generate a second scene comprising motion of media content associated with the images, the motion provides a movement pattern to the media content during different viewpoints at respective timesteps of the second scene.

20. The computer-readable medium of claim 19, wherein the instructions, when executed, further cause:
applying a color of the content of the frames to a color of the media content such that the media content of the second scene comprises the color of the content of the frames.
